(19) United States
(12) Patent Application Publication
(10) Pub. No.: US 2025/0295482 A1
(43) Pub. Date: Sep. 25, 2025

(54) Automatic generation of a crown shape for a dentition

(71) Applicants: Julian Mathieu Schoep, Amsterdam (NL); Timme Pleun van Der Meer, Amsterdam (NL); Agoston Zsolt Török, Amsterdam (NL); Mathieu Guindon, Basel (CH)

(72) Inventors: Julian Mathieu Schoep, Amsterdam (NL); Timme Pleun van Der Meer, Amsterdam (NL); Agoston Zsolt Török, Amsterdam (NL); Mathieu Guindon, Basel (CH)

(21) Appl. No.: 19/034,534

(22) Filed: Jan. 22, 2025

Related U.S. Application Data
(63) Continuation-in-part of application No. PCT/EP2024/070043, filed on Jul. 15, 2024.

(30) Foreign Application Priority Data
Jul. 18, 2023 (EP) 23186237.6

(51) Int. Cl. A61C 13/00; G06T 19/20

(52) U.S. Cl. CPC A61C 13/0004; G06T 19/20; G06T 2200/24; G06T 2210/41; G06T 2219/2021

(57) ABSTRACT

Methods and systems for automatic generation of a crown shape for a dentition comprise segmenting 3D maxillofacial data into a set of 3D dental objects; determining/receiving a position of a tooth determining 3D spatial constraints for the target crown shape using the set of 3D dental objects; determining an initial pose based for the target crown shape based on 3D dental object(s) of the set of 3D dental objects; and, optimizing parameter(s) associated with a digital crown shape model to determine the target crown shape, including determining a trial crown shape using the digital crown shape model and the parameter(s), computing a loss value for the trial crown shape based on the 3D spatial constraints and the initial pose; and, if the loss value does not meet one or more optimization conditions modifying the parameter(s) to determine a further trial crown shape and to compute a further loss value.

### TECHNICAL FIELD

The disclosure relates to automatic generation of a crown shape for a dentition, and in particular, though not exclusively, to methods and systems for automatic generation of a crown shape for a dentition and a computer program product for executing such methods.

### BACKGROUND

The discussion below is merely provided for general background information and is not intended to be used as an aid in determining the scope of the claimed subject matter.

With the advances of digital technology parts of the process of producing a crown have been automated using digital equipment such as an intra-oral scanner (IOS) for generating a 3D intra-oral scan of a dentition and dental design software. Such software may assist a person with domain knowledge to create a digital design of a crown shape, which can be used in a computer-aided manufacturing process such as 3D printing or numerically controlled milling.

Accurate fully automatic design of a digital representation of a crown shape for a tooth that is missing from a dentition based on 3D maxillofacial data is a highly complex process. To that end, dental restoration schemes have been suggested based on machine learning. For example, US2022/0296344 and WO2022/016294 describe a dental restoration system comprising a model that is trained using historical training data representing a 3D maxillofacial structure of a dentition to generate a digital crown shape for the missing tooth. Training a crown shape model requires large amounts of annotated 3D maxillofacial data sets to train a neural network to generate a crown shape. Additionally, these models rely on locations in a dentition that already include an abutment or a preparation that is fixated by a screw in the jaw of a patient. Hence, these models also rely on other information, such as the pose of the abutment, than the information that can be extracted from a dentition produced by a model. More generally, it is very difficult to train a deep learning model only based on 3D maxillofacial structures of dentitions to generate a specific crown shape for a missing tooth in a dentition.

Hence, from the above it follows that there is a need in the art for improved methods and systems for automatic crown generation.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a non-transitory computer readable storage medium. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The embodiments in this disclosure aim to provide methods and systems for automatic generation of crown shapes based on 3D maxillofacial data comprising a dentition.

In an aspect, the embodiments may relate to a computer-implemented method for automatic generation of a crown shape for a dentition, the method comprising:
determining an optimized crown shape for a tooth position in the dentition using a digital crown shape model, the digital crown shape model being associated with optimization information, the optimization information including one or more optimization parameters, the optimization comprising: generating a trial crown shape using the digital crown shape model; computing a loss value for the trial crown shape based on 3D spatial constraints associated with the dentition and an initial pose of the crown; and iteratively minimizing the loss by modifying the one or more optimization parameters until one or more optimization conditions are met; displaying the optimized crown shape at the tooth position within the dentition and a graphical user interface GUI associated with the displayed optimized crown shape, the GUI being configured to receive user input for modifying at least part of the optimization information; in response to user input for modifying the at least part of the optimization information, determining a re-optimized crown shape using the digital crown shape model based on the modified optimization information; and; displaying the optimized crown shape at the tooth position within the dentition.

In an embodiment, the optimization information presented by the GUI may include at least one of: a crown pose, one or more landmarks, an emergence line, an FDI number, one or more dental corridors, one or more crown shape parameters.

In an embodiment, the digital crown shape model may be defined as a linear combination of different basic crown shapes of a tooth wherein the shape parameters represent the coefficients associated with each basic crown shape defining at least part of the one or more optimization parameters.

In an embodiment, the digital crown shape model may comprise at least one trained deep neural network, preferably a DeepSDF-based model, that is trained to generate different crown shapes as a function of one or more optimization parameters provided to the input of the trained neural network, wherein the optimization parameters control at least a shape of the crown shape and, optionally, a pose of the crown shape.

In an embodiment, the re-optimization of the digital crown model may comprise: receiving one or more modified values corresponding modified optimisation information from the graphical user interface; computing a loss value based on the modified optimisation information and using the digital crown shape model; and, minimizing iteratively the loss by updating the crown shape parameters and/or the pose parameters until the loss satisfies one or more optimization conditions.

In an embodiment, the re-optimization of the digital crown model after user modification of the crown shape parameters may further comprise: receiving the optimized crown shape parameters which corresponding to the digital crown model and the generated crown shape displayed in the GUI; extracting one or more features from the crown shape parameters, wherein the extraction comprises identifying features that represent variations in the crown shape parameters; labelling a predefined set of the extracted features; regenerating the crown shape parameters based on the set of labelled features; providing labelled set of features as editable inputs in the GUI; and, using the modified values of the labelled features to further optimize the crown pose by iteratively minimizing a loss function, wherein the loss function is minimized by updating the crown pose parameters until one or more optimization conditions are satisfied.

In an embodiment, extracting one or more features from the crown shape parameters may comprise performing principal component analysis (PCA) to reduce the dimensionality of the crown shape parameter space, wherein the principal components represent the most significant variations in the crown shape geometry.

In an embodiment, extracting one or more features from the crown shape parameters may comprise using an auto-encoder neural network to reduce the dimensionality of the crown shape parameter space, wherein the latent representation produced by the auto-encoder encodes the most significant geometric and structural variations in the crown shape geometry.

In an embodiment, labelling the extracting features may comprise: assigning semantic labels to the extracted features either manually or automatically, wherein the labels correspond to crown shape characteristics including at least crown size, cusp sharpness, curvature, surface texture, tooth wear, tooth age.

In an embodiment, the automatic labelling of the extracted features may be based on a trained machine learning model that was trained to learn the correlation between the crown shape characteristics and the extracted features.

In an embodiment, a preview of the digital crown shape may be generated after user modification of optimization information.

In an embodiment, the generation of the preview of the digital crown shape may include: applying one or more transformations to the crown shape to generate the preview, wherein the one or more transformation adjusts the crown shape to approximate alignment with the modified optimization information without altering the crown shape parameters; and, displaying the crown shape preview in the GUI to provide visual feedback of the modifications.

In a further aspect, the embodiments may relate to a system for automatic generation of a crown shape for a dentition comprising: a computer readable storage medium having computer readable program code embodied therewith; and a processor, preferably a microprocessor, coupled to the computer readable storage medium, wherein responsive to executing the computer readable program code, the processor is configured to perform executable operations comprising: determining an optimized crown shape for a tooth position in the dentition using a digital crown shape model, the digital crown shape model being associated with optimization information, the optimization information including one or more optimization parameters, the optimization comprising: generating a trial crown shape using the digital crown shape model; computing a loss value for the trial crown shape based on 3D spatial constraints associated with the dentition and an initial pose of the crown; and iteratively minimizing the loss by modifying the one or more optimization parameters until one or more optimization conditions are met; displaying the optimized crown shape at the tooth position within the dentition and a graphical user interface GUI associated with the displayed optimized crown shape, the GUI being configured to receive user input for modifying at least part of the optimization information;
in response to user input for modifying the at least part of the optimization information, determining a re-optimized crown shape using the digital crown shape model based on the modified optimization information; and; displaying the optimized crown shape at the tooth position within the dentition.
   In an embodiment, the executable operations may further comprise any of the method steps as described above.

In an aspect, embodiments may relate to a computer-implemented method for automatic generation of a crown shape for a dentition comprising: segmenting 3D maxillofacial data comprising the dentition into a set of 3D dental objects; determining or receiving a position of a tooth, in the dentition for which a target crown shape is to be determined; determining 3D spatial constraints for the target crown shape based on the set of 3D dental objects; determining an initial pose based for the target crown shape based on one or more 3D dental objects of the set of 3D dental objects; and, optimizing one or more optimization parameters of a digital crown shape model to determine the target crown shape, the optimizing including determining a trial crown shape using the digital crown shape model and the one or more optimization parameters, computing a loss value for the trial crown shape based on the 3D spatial constraints and the initial pose; and, if the loss value does not meet one or more optimization conditions modifying the one or more shape parameters to determine a further trial crown shape and to compute a further loss value.

The method allows automatic design of a crown shape based on 3D maxillofacial data comprising the dentition. Hence, a crown shape can be designed solely based on 3D maxillofacial data comprising the dentition of a patient. Further, the method only requires optimization of a model of a crown shape, while the 3D constraints associated with the other teeth in the dentation can be processed using a loss function.

In an embodiment, the segmentation of the teeth in the 3D maxillofacial data may be based on one or more trained deep neural networks.

In an embodiment, the one or more optimization parameters may include one or more shape parameters associated with the digital crown shape model, the one or more optimization parameters being configured to control the shape of trial model generated by the digital crown shape model.

In an embodiment, the one or more optimization parameters may include one or more pose parameters for controlling the pose of the trial crown model, preferably the one or more pose parameters including parameters for controlling the rotation translation and/or scaling of the trail crown model.

In an embodiment, the 3D spatial constraints may include at least one of:
a space defined by the boundaries of dental arches determined on the basis of the 3D dental objects; a closed interproximal distance (distoma) between the trial crown shape and neighboring teeth in the dentition; no collision between the trial crown shape and neighboring teeth in the dentition; the pose of the target crown shape is less than a threshold value of less than 0.1 millimetres, preferably 0.05 millimetres, more preferably approximately 0.02 millimetres to the pose of neighboring teeth.

The automatic generation of a crown shape according to the embodiments in this application work on all FDI locations and not just a single posterior crown position. In addition, through extrapolation, the method also allows the generating a crown model for the last molar where a neighbour is missing. Both optical scans and CBCT scans can be used as input for generating the crowns, thus providing a flexible solution for potential clinical applications. The results are clinically relevant to help inform implant placement.

Hence, the method determines intermediate information based on 3D maxillofacial data comprising the dentition (such as segmented 3D dental objects and the tooth numbers) which is then for determining spatial constraints which are used to tune (optimize) the optimization parameters of a digital crown shape model.

In an embodiment, the modifying of the one or more optimization parameters, the determining of a trial model shape and the computing a cost value for the trial model shape is repeated until the cost value meets the one or more optimization conditions.

In an embodiment, the initial pose may be determined based on the pose of one or more 3D dental objects neighboring the location of the tooth in the dentition for which the target crown shape is generated.

In an embodiment, the 3D spatial constraints may include a plurality of dental arches, the plurality of dental arches being determined based on the set of 3D dental objects, the plurality of dental arches forming boundaries of a 3D space in which the trial crown shape should be contained.

The 3D dental constraints may be learned from the regularity of dental positions in human anatomy. This could be manifested by any representation that can constrain the location of the crown, including but not limited to dental arches, predicted crown surface points, and/or a crown shape of a tooth that conforms to the antagonist dental arch.

In an embodiment, the digital crown shape model may define the trial crown shape as a linear combination of different basic crown shapes of a tooth, preferably the contribution of each basic crown shape to the trial crown shape being determined by a coefficient, the coefficients associated with each basic crown shape defining at least part of the one or more optimization parameters.

In an embodiment, each basic crown shape may be represented by a 3D mesh, the 3D meshes representing the basic crown shapes having the same number of points, the data format of the 3D mesh being configured so that a one-to-one correspondence exist between points of the 3D meshes.

In an embodiment, the digital crown shape model may comprise at least one trained deep neural network that is trained to generate different crown shapes as a function of one or more optimization parameters provided to the input of the trained neural network.

In an embodiment, the trained deep neural network may be configured to produce a latent representation, preferably a low-dimensional latent representation such as signed distance function (SDF) representation, of the trial crown shape as a function of at least one optimization parameter provided to the input of the trained neural network.

In an embodiment, the trained deep neural network may be a decoder model configured to generate the low dimensional latent representation, preferably a signed distance function (SDF) representation, of the trial crown shape and wherein the at least one optimization parameter is a latent code.

In an embodiment, the method may further comprise transforming the latent representation of the trial crown shape into a mesh representation of the trial crown shape.

In an embodiment, each basic crown shape may be represented by a 3D mesh, preferably defined by vertices, edges, faces, polygons and/or surfaces, wherein each of the meshes being defined based on an equal number of faces, polygons or surfaces and wherein a location of a landmark, such as cusp, may be represented by the same face, polygon or surface.

In an embodiment, the 3D meshes defining the basic crown shape need to have same number of points (thereby creating same number of faces, polygons or surfaces) and a dense one-to-one correspondence between the points that allows arrangement of points in same order along the meshes.

Hence, a wide range of tooth-like mesh shapes may be created from the basic crown shapes. By using the same amount of triangles and correspondence of points for each mesh shape the shapes can be combined to a large variety of dental shapes of a certain tooth type.

In a further aspect, the embodiments may relate to a system for automatic generation of a crown shape for a dentition comprising: a computer readable storage medium having computer readable program code embodied therewith; and a processor, preferably a microprocessor, coupled to the computer readable storage medium, wherein responsive to executing the computer readable program code, the processor is configured to perform executable operations comprising: segmenting 3D maxillofacial data comprising the dentition, preferably by one or more trained deep neural networks, into a set of 3D dental objects; determining or receiving a position of a tooth, preferably based on a tooth classifier, in the dentition for which a target crown shape is to be determined; determining 3D spatial constraints for the target crown shape based on the set of 3D dental objects; determining an initial pose based for the target crown shape based on one or more 3D dental objects of the set of 3D dental objects; optimizing one or more shape parameters of a digital crown shape model to determine the target crown shape, the optimizing including determining a trial crown shape using the digital crown shape model and the one or more shape parameters, computing a loss value for the trial crown shape based on the 3D spatial constraints and the initial pose; and, if the loss value does not meet one or more optimization conditions modifying the one or more shape parameters to determine a further trial crown shape and to compute a further loss value.

In an embodiment, the digital crown shape model may define the trial crown shape as a linear combination of different basic crown shapes of a tooth, wherein a contribution of each basic crown shape to the trial crown shape is determined by a coefficient, the coefficients associated with each basic crown shape defining the one or more shape parameters of the digital crown shape model.

In an embodiment, the digital crown shape model may comprise at least one trained deep neural network that is trained to generate different crown shapes as a function of a shape parameter that is provided to the input of the trained neural network;
preferably the trained deep neural network being an auto-decoder which is trained to generate a signed distance function representation of a trial crown shape, the method further including: transforming the signed distance function representation of the trial crown shape into a mesh representation of the trial crown shape.

The embodiments may also relate to a computer program product comprising instructions which, when the program is executed by a computer, cause the computer to carry the method steps according to any of the method steps as described above.

### BRIEF DESCRIPTION OF THE DRAWINGS

FIG. 1 depicts a method for determining 3D spatial constraints for automatic crown generation according to an embodiment;

FIGS. 2A and 2B illustrate an example of a crown model comprising anatomical landmark points;

FIGS. 3A and 3B illustrate segmented teeth of a dentition comprising anatomic landmark points;

FIG. 4A-4C depict dental corridors which are determined based on the landmarked segmented tooth;

FIG. 5 illustrates an example of an optimization module for automatically determining according to an embodiment;

FIG. 6 illustrates an example of an optimization module for automatically determining according to an embodiment;

FIG. 7 depicts a flow chart of a method of automatic crown generation according to an embodiment;

FIG. 8A-8F depict the evolution of a tooth shape during the optimization process according to an embodiment;

FIG. 9 illustrates an example of a workflow for user-interactive automatic generation a crown shape according to an embodiment;

FIG. 10 illustrates schematic of a process for generating, editing, and optimizing a crown shape according to an embodiment;

FIG. 11 illustrates a process for generating, editing, and refining a digital crown shape model through user interaction according to another embodiment;

FIG. 12A-12C illustrate GUIs for the initial crown shape generation according to an embodiment;

FIG. 14A-14C illustrate GUIs for rendering the updated, generated crown shape according to an embodiment;

FIG. 13A-13F illustrate GUIs for user-driven optimisation variables editing according to an embodiment;

FIG. 15A-15C illustrate a process of previewing and re-optimizing a digital crown shape after user modifications to optimization information;

FIG. 16 is a block diagram illustrating exemplary data processing systems described in this disclosure.

### DESCRIPTION OF THE EMBODIMENTS

The embodiments in this disclosure generally relate to methods and systems for automatic generation of a digital representation of a crown shape for a dentition. The method for automatic crown shape generation may use 3D spatial constraints derived from 3D maxillofacial data comprising a dentition which may have at least one missing tooth for which a crown shape needs to be designed. This crown shape may be referred to as the target crown shape.

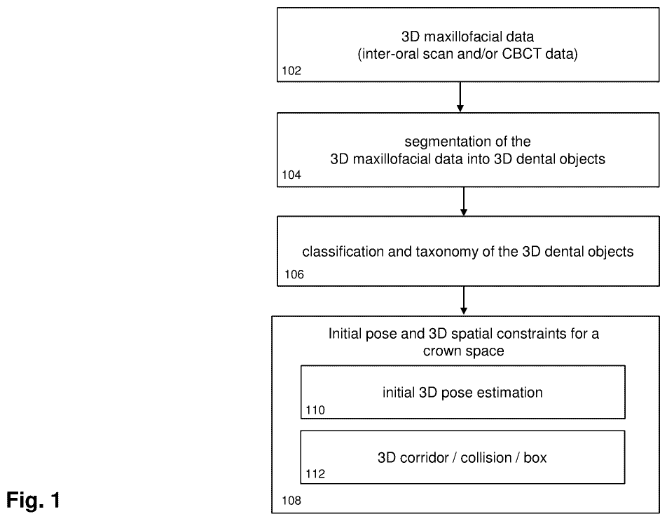

FIG. 1 depicts a method for determining 3D spatial constraints for automatic crown shape generation based on 3D maxillofacial data comprising a dentition. As shown in the figure, the method may start with receiving 3D maxillofacial data, e.g. (CB) CT data or scanning data such as intra-oral scanning IOS data, comprising a dentition (step 102). In some embodiments, the dentition may have one or more missing teeth.

A segmentation process may be used to segment the 3D maxillofacial data comprising the dentition into individual segmented 3D dental objects (step 104), e.g. segmented teeth. Typically, a 3D dental object may be surface representations, e.g. a mesh-representation of a particular tooth. Further, the 3D dental objects may be classified into different tooth types (step 106) and each of the 3D dental objects may be linked to a position in the 3D space of the 3D maxillofacial data. This way, a tooth type classifier, for example an FDI number, may be assigned to each of the 3D dental objects. The tooth type classifier links a 3D dental object to a certain tooth type which has a predetermined position in the dentition.

Accurate segmentation and classification of 3D maxillofacial data into 3D dental objects, such as teeth and gingiva, may be based on one or more trained neural network systems. Examples of such trained neural network systems are described in WO2021009258 and WO2019002631, which are hereby incorporated by reference in this application. Based on these segmentation and classification schemes, a set of taxonomized 3D dental objects may be determined, wherein each of the 3D dental objects is associated with a tooth type classifier. The taxonomized 3D dental objects and the gingiva may be used to produce an accurate model of a dentition of a patient. Such models may be used in digital dental and orthodontic treatment planning applications. In an embodiment, based on the set of taxonomized 3D dental objects, one or more missing teeth and/or molars may be automatically determined.

Further, an initial pose and 3D spatial constraints for the target crown shape may be determined (step 108). To that end, a library or database of basic crown shapes may be used. The library may contain for each tooth number, a plurality of different basic crown shapes. Further, each crown shape may be associated with a pose, i.e. an orientation in the 3D space in which the basic crown shapes are defined. Further, the standard crown shapes may be provided with anatomical landmark points. These landmark points are positioned on relevant locations such as a cusp, groove or equatorial point. These landmark points identify the locations of anatomical relevant parts of a basic crown shape. These landmarks may be used in determining the pose of the tooth for which a crown shape needs to be designed.

Basic crown shapes in the database associated with the tooth number of a 3D dental object may be selected and compared with the 3D dental object. The pose of the basic crown shape that provides the closest match with the crown shape of the 3D dental object may be used as an estimate for the pose for the 3D dental object. This way, the pose of all 3D dental objects may be determined.

Different matching algorithms may be used for matching the 3D dental objects. In an embodiment, an interactive closest point (ICP) algorithm may be used, In other embodiments, iterative distance minimization with an optimizer or another suitable algorithm may be used to match the crown shape of a 3D dental object with one of a set of standard crown shapes. The basic crown shape that matches a 3D dental object best, i.e. it has the closest distance to the existing tooth (lowest reproduction error), may be used to get the anatomical annotations on the 3D dental object. After matching the basic crown shape, the anatomical annotations of the basic crown shape may be transferred to the 3D dental object to form annotated 3D dental objects.

Based on the pose of the 3D dental objects that neighbour the tooth for which a target crown shape needs to be designed, an initial pose for the target crown shape may be estimated (step 110). For example, the initial pose of the target crown shape may be estimated based on an average of the poses of neighboring teeth.

Hence, by using a matching algorithm as described above on the standard crown shapes in the database, or by using a neural network trained on such data, segmented 3D dental objects with anatomical landmark points may be obtained. Alternatively, a trained neural network can detect the location of the landmarks. This way, each 3D dental object of a dentition in the 3D maxillofacial data may be provided with anatomically relevant landmark points. Based on the anatomical landmark points, so-called dental corridors may be created, which may serve as 3D constraints for computing a cost in a crown shape optimization scheme (step 112).

In a further embodiment, 3D constraints may be obtained by training a neural network to predict sparse surface points of the crown to be designed. These sparse surface points can—for example—be used to determine a volume in which the crown shape should fit and/or to determine dental arches.

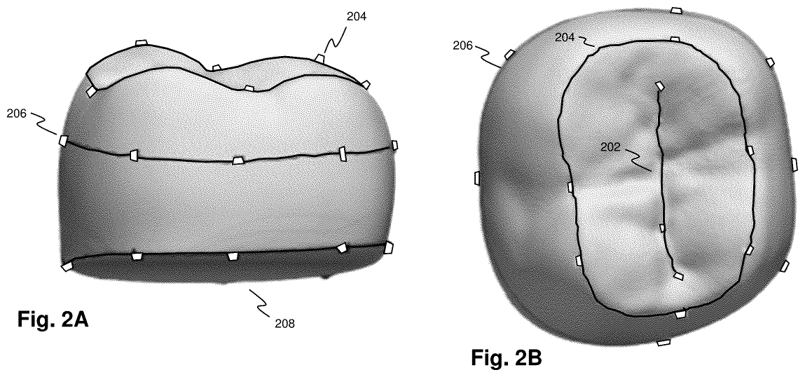

FIGS. 2A and 2B illustrate an example (a side view and a top view respectively) of a plurality of standard 3D crown shapes for a predetermined tooth number. The 3D crown shapes may be represented by any suitable 3D data format including but not limited to a 3D point cloud, a 3D mesh or voxels. As shown in the figure, the crown model may include different anatomical annotations 202₁₋₄, which define clinically relevant landmark points on the surface of the tooth. The figures illustrate anatomical annotations of a standard 3D crown shape including groove landmark points 202, cusp landmark points 204, equatorial landmark points 206 and cervical landmark points 208. Typically, these annotations are not directly available for the 3D dental objects obtained by processing 3D maxillofacial data of a patient. To provide 3D dental objects that are derived, e.g. segmented, from 3D maxillofacial data of a patient with anatomical landmark points the methods described with reference to FIG. 1 may be used.

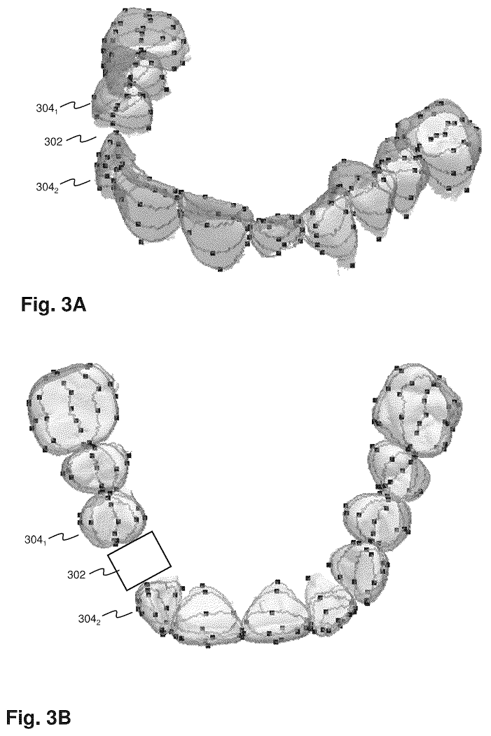

FIGS. 3A and 3B show two views of a segmented dentition comprising 3D dental objects comprising anatomic landmark points according to an embodiment. The landmarked 3D dental objects may be generated using the method described with reference to FIG. 2, which includes:
1) matching the crown shape of each of the segmented 3D dental objects of the dentition to a set of annotated basic crown shapes; and,
2) transferring anatomical landmark points from a basic crown shape that matches the crown shape of a segmented 3D dental object to the 3D dental object.

As shown in the figures, one or more tooth position 302 may be identified where a tooth is missing and for which a crown shape needs to be designed. Further information that is important for the crown shape modelling are a tooth or teeth 304_{1,2} that is or are neighboring a missing tooth respectively and opposing jaw with teeth (also known as antagonist in the literature). These neighboring teeth may also define spatial constraints for the crown that needs to be designed by the model. Moreover, based on the pose of the neighboring teeth an initial pose for the target crown shape may be determined.

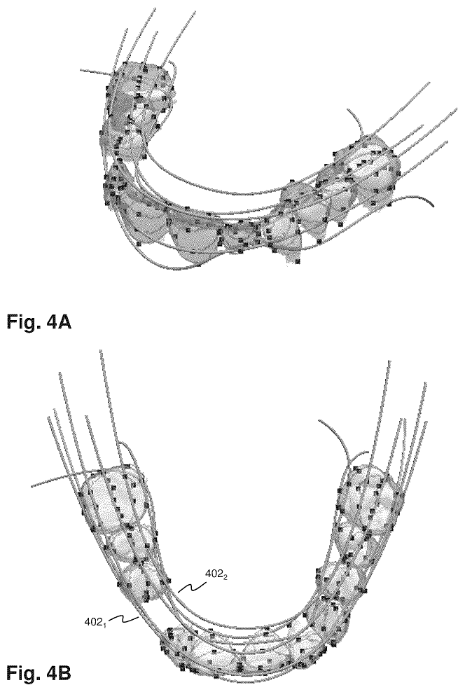

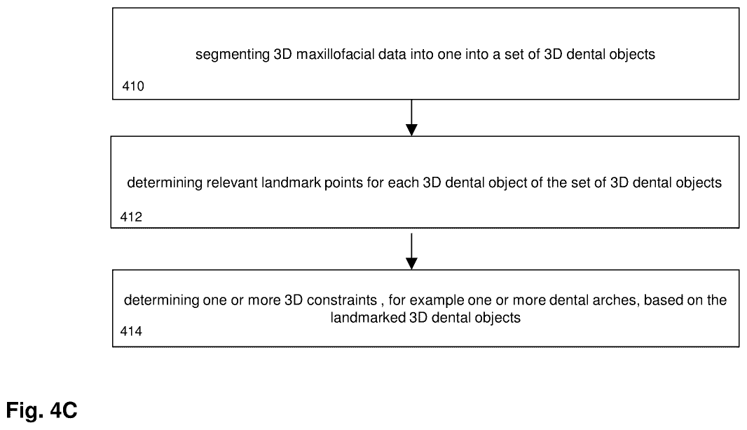

Anatomical annotations may be determined for the 3D dental objects of the dentition and one or more (typically a plurality of) dental corridors may be defined by linking identical or related anatomical landmark points of different 3D dental objects, e.g. neighboring 3D dental objects. FIGS. 4A and 4B depict different views of a plurality of dental corridors determined based on landmarked 3D dental objects of a dentition. Corridors may be defined by fitting a curve, e.g. polynomial curve, through relevant points. In an embodiment, a fitting polynomial according to the following expression may be used (equation 1):

$$F ( x \vert a , b , c , t ) = \vert a \vert {( x - t )}^{4} + \vert b \vert {( x - t )}^{2} + c \qquad ( 2 )$$

where a, b, c, t are parameters of the polynomial model. For example, landmark points of 3D dental objects on the outer side of the dentition may be selected. For example, the landmarks on the tooth outer cusps can be used and fitted to define an outer dental corridor 3041. In a similar way, landmark points of 3D dental objects on the inner side of the dentition may be selected and fitted to define an inner dental corridor 3041. This way a plurality of dental corridors may be generated which may define the 3D constraints that may be used in computing a 3D shape of a 3D dental object that is missing from the dentition.

FIG. 4C depicts a flow chart of a process of determining 3D constraints for computing a crown shape for a dentition comprising a missing tooth. As explained above these 3D constraints are determined from 3D maxillofacial data comprising a dentition of a patient that misses one or more teeth. The process may include segmenting 3D maxillofacial data into one into a set of 3D dental objects (step 410). The segmentation process may generate a set of segmented 3D dental objects and location information, e.g. positions of the 3D dental objects in the space of the coordinate system of the 3D maxillofacial data, e.g. CBCT data or mesh data. Then, clinically relevant landmark points may be provided for each 3D dental object of the set of 3D dental objects (step 412). In an embodiment, a 3D dental object may be annotated with landmark points by fitting each 3D dental object to a plurality of basic crown shapes which are annotated with landmark points and using the best fitted basic crown shape to transfer the landmark point to the 3D dental object. In other embodiment, a deep neural network may be trained to receive a 3D dental object and to output landmark points for the 3D dental object. Based on the annotated 3D dental objects, 3D constraints, such as a plurality of dental arches may be determined. The landmark point may be one point or a set of points, e.g. a point cloud, associated with a 3D dental object, wherein the point or set of points indicates clinically relevant locations or areas on a 3D dental object that can be used to determine a 3D dental object.

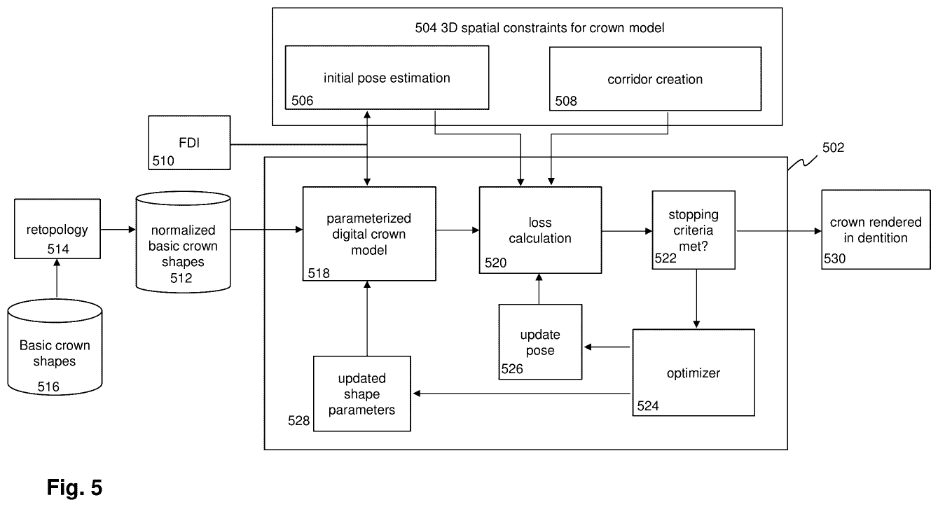

FIG. 5 depicts an optimization module 502 for executing a method for generating a crown shape generation according to an embodiment. As shown in the figure the optimization module 502 may be configured to receive information that is needed for the optimization process. This optimization information may include an estimate of the initial pose 506 of the target crown shape and 3D constraints, such as dental corridors 508 as described with reference to FIG. 1-4.

The input data may further include information 510 regarding the missing tooth, such as the tooth number, which identifies the location of the tooth for which a target crown shape needs to be generated. In an embodiment, the tooth number may be determined automatically, e.g. during the segmentation of the 3D maxillofacial data as described with reference to FIG. 1. In another embodiment, the tooth number may be provided by a user of the system.

The system may comprise a database for storing for each tooth number of a dentition a set of standard crown shapes 512. These sets of standard crown shapes may be used to determine the initial pose and the 3D constraints as described above with reference to FIG. 1-4. To ensure consistent processing of the basic crown shapes data structures may need to be normalized and standardized. To that end, a retropology technique 514 may be used to determine normalized basic crown shapes, wherein each normalized basic crown shape is represented by the same data format of a mesh shape. For example, each normalized basic crown shape may be represented by a mesh shape data format having the same number of vertices. These vertices may be represented using a two dimensional array of size N by 3 where N is total number of vertex points and where each point corresponds to the same tooth location so that the points have dense correspondence across normalized basic tooth shapes. For example, in case the basic crown shapes and the target crown shape are represented as a polygon mesh, the crown shapes may be stored and processed based on a data format that include a collection of vertices, edges and/or surfaces that define the shape of the crown. Known mesh representations may be used including but not limited to face-vertex meshes, winged-edge meshes, half-edge meshes, quad-edge meshes or corner-table meshes.

Normalized basic crown shapes belonging to the same FDI tooth position may be formed. To that end, in an embodiment, for each basic crown shape, a sphere mesh may be morphed into a crown shape that matches the basis crown shape. Each sphere mesh that is used to be shaped as a normalized basic crown shape which is represented in a data format comprising array of coordinates defining a fixed, predetermined number of vertices arranged in a predetermined order. This way, different normalized basis crown shapes of one particular tooth number can be formed. The normalized basis crown shapes comprise the same number of vertices and in the same order so that they can be combined to create a new crown shape. Every vertex coordinate of a new crown shape (a trial crown) may be formed by a linear combination of the same vertex coordinates of the normalized basic crown shapes. The linear combination weights may be selected per basic tooth shape. In that case, the weights are shared by all vertex coordinates of a basic tooth shape. The sum of all linear combination weights add up to one trial model.

The optimization module may be configured to execute an optimization scheme to determine a target crown shape that fits a crown space which is defined by the 3D constraints. The optimization scheme may be configured to optimize one or more shape parameters of a digital crown shape model 518. The optimization scheme may start with an initial crown shape. Such initial crown shape may be generated based on the set of normalized basic crown shapes 512. This initial crown shape may be used as a trial function in the optimization loop.

A loss function 520 may be used to compute a loss for the trial crown shape. The loss computation will be based on the initial pose and the 3D spatial constraints and the computed loss value provides a measure of how good the trial crown shape fits the space defined by the 3D spatial constraints and the initial pose. If the loss calculation indicates that the trial crown shape does not fit the crown space sufficiently well, an optimizer 524 may modify the shape parameters so that these modified shape parameters can be used by the digital crown shape model to generate a further trial crown model and to compute a further loss value. In some embodiments, in addition to the update of the shape parameters also the pose of the target may be updated by the optimizer. The optimized may use known algorithms such as stochastic gradient decent (SGD) or Adam to modify the optimization parameters. The updated pose 526 may be used in the computation of the loss value. The modification of the one or more shape parameters, the (optional) modification of the pose of the target crown shape, the determining of a trial model shape and the computing of a cost value for the trial model shape may be repeated until one or more optimization conditions are met such as early stopping criteria, maximum number of iteration or a threshold on cost value. Thereafter, the optimized target crown shape may be rendered together with the other 3D dental objects of the dentition that were derived from the 3D maxillofacial data.

Hence, the optimization scheme shown in the figure updates the shape and pose of a trial crown shape until the loss value indicates that the trial crown shape has reached an optimal shape in view of the 3D constraints, in particular the 3D dental corridors. The spatial constraints for a target crown shape may be defined based on one or more rules for example:
the target crown shape should remain within the space that is defined by the boundaries of the dental corridors;
a closed interproximal distance (distoma) between the target crown shape and the neighboring teeth is needed;
no collision between the target crown shape and neighboring teeth may occur;
the orientation of the target crown shape is close to the orientation of neighboring teeth.

These rules may be implemented in the optimization scheme as loss components. One loss may be related to the tooth pose, where if it deviates too much from the initial estimation in occlusal direction it will generate a positive loss value to ensure no tooth deviation from initial occlusal direction is obtained. Another example is the constraint to remain within the dental corridors. This loss may be added to the optimization scheme as a chamfer loss, such as a soft one-way chamfer loss. Contact point losses, i.e. losses related to a trail crown shape contacts a neighboring teeth, may be added as a point-to-point least squared error (L2) loss in the mesio-distal direction. Avoiding collision with neighboring teeth may be added as collision loss which inflicts a penalty when the trial crown shape collides with one of its neighboring teeth. Such loss may be computed as described in the article by Engelmann et al “From points to multi-object 3D reconstruction.” Proceedings of the IEEE/CVF Conference on Computer Vision and Pattern Recognition. 2021, which is hereby incorporated by reference into this application.

Different digital crown shape models may be used in the optimization scheme of FIG. 5. In an embodiment, the digital crown shape model may be defined as a linear combination of normalized tooth crown shapes. Inventors found that most of the natural teeth variations are part of a subspace formed by the set of basic tooth shapes. This way, most of the natural tooth shapes can be determined based on a weighted combination of different normalized basic crown shapes of a certain tooth number. In such scheme a model based on two basic shapes would only be able to generate teeth of a shape that forms an interpolation between the two shapes. For every additional ‘different’ basic tooth shape, the model will become more flexible/expressive in terms of shape generation. Typically, ten or more basic tooth shapes may be determined to have variations between the shapes to fit into any denture (from worn and thin to feature rich and fat). Based on this insight, a crown shape model may be defined as a linear function of the normalized basic tooth shapes that are stored in database 516. The normalized basic tooth shapes may be referred to as eigen tooths. This way, a linear crown shape model may define a trial crown shape T_{designed} as a weighted combination of individual normalized basic crown shapes Tᵢ (equation 2):

$${T}_{Designed} = {α}_{1} {T}_{1} + {α}_{2} {T}_{2} + … + {α}_{n} {T}_{n}$$

wherein αᵢ is a coefficient associated with the i-th normalized basic crown shape Tᵢ. The coefficients associated with the normalized basic crown shapes may define the contribution of each normalized basic crown shape to a trial crown shape. This way normalized basic crown shapes can be combined to generate any natural crown shape based on the set of coefficients. The coefficient may define one or more shape parameters which can be modified and optimized based on an optimization scheme as described with reference to FIG. 5. The linear tooth model requires that the eigen teeth can be combined (“added”) to form a resulting crown shape.

As already described above, typically, the basic teeth shapes may be defined as 3D meshes, i.e. a 3D model of polygons. The polygons that are used to model a 3D dental object are geometric shapes, such as quadrangles or triangles, which can be further broken down into vertices (defined by x, y, z coordinates of the coordinate system of a 3D mesh) and lines. Hence, a dense one-to-one correspondence between vertices of the meshes that represent the different crown shapes is needed to weighted combinations of normalized basic crown shapes possible. To that end, a normalization method may be used to normalize each of the 3D meshes representing a basic crown shape (as stored in a library 516) into normalized basic crown shapes. The normalized basic crown shapes belonging to the same FDI tooth have the property that they can be combined to form different shapes based on a linear interpolation scheme.

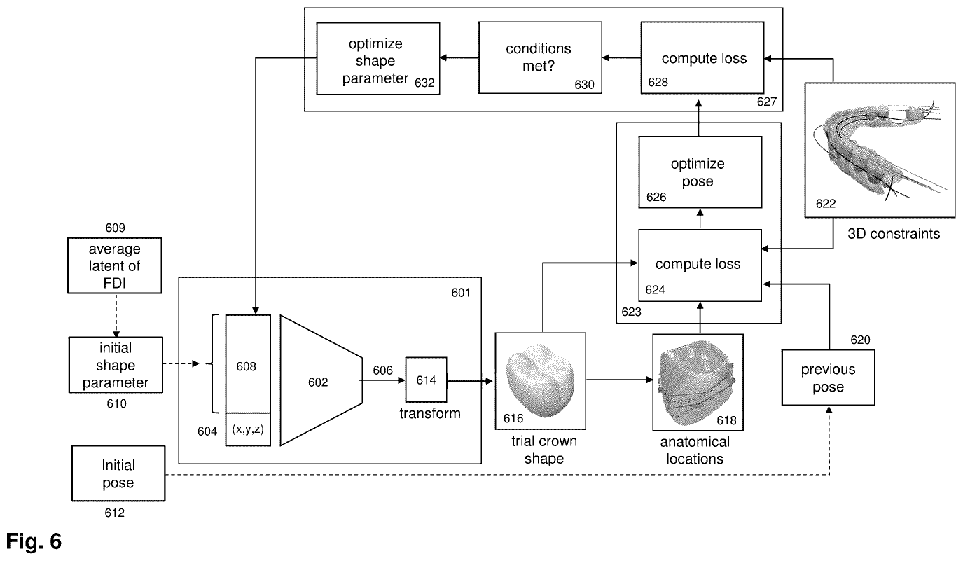

In another embodiment, the digital crown shape model may be based on a machine learning scheme, wherein a crown shape model may be optimized on the basis of a shape parameter. In this embodiment, a crown shape model may be trained to represent different crown shapes based on a shape parameter that is provided to the input of the crown shape model. An example of such optimizable crown model based on a trained deep neural network is described hereunder with reference to FIG. 6.

FIG. 6 illustrates an example of an optimization module for automatically determining according to an embodiment. As shown in the figure, the module may include a machine learning model 601 configured to receive input parameters 610, 634, in particular a shape parameter, and configured to generate an output in the form of an approximated crown shape, i.e. a trial crown shape 616, that needs to be generated based on 3D constraints 622. The constraints may be determined based on 3D maxillofacial data of a patient as described above with reference to FIG. 1-4. The crown shape may be represented using a digital data format for 3D models such as a mesh format.

The module may be configured to generate a crown shape by using the shape parameter and, optionally, the pose of the tooth for which the crown shape needs to be generated as optimization parameters. To that end, the module may be configured to receive initial optimization parameters, such as an initial shape parameter 610 and an initial pose 612. A pose optimizer 623 may be configured to receive a trial crown shape 606 generated by the machine learning model. The trial crown shape 616, the pose 620 (either the initial pose or an updated pose) and the 3D constraints 622 may be used by a first loss function 624 to compute a first loss value. In some embodiments, before provided to the pose optimizer, the trial crown shape may be provided with anatomic landmarks 618 in a similar way as described above with reference to FIG. 1-4. The computed first loss value may be used by a first optimization algorithm 626 to determine a trial crown shape with an updated pose. This updated trial crown shape may be provided to a shape optimizer 627 comprising a second loss function 628 which is configured to compute a loss value based on the updated trial crown shape and the 3D constraints 622. The second loss value may be used to determine if one or more optimization conditions 630 are met. If this is not the case, the second loss value may be used to determine one or more new shape parameters 632, which may be provided to the input of the machine learning model to determine a new trial crown shape. This process may be repeated a number of times until at least one of the one or more optimization conditions is met.

It is submitted that the optimization scheme illustrated in FIG. 6 is a non-limiting example and many different implementations may be possible without departing from the teaching of the embodiments. For example, the pose optimizer and the shape optimizer may be implemented in one optimization module in which a loss function is used to compute one or more loss values is computed which may include a loss part for the pose and a loss part for the shape and an algorithm that may compute an updated pose and shape parameters using the 3D constraints. Here, the loss function may be configured to compute collision losses, which provide a measure for the extent to which a trial crown shape positioned at a location in the dentition overlaps with neighboring tooth; and may be configured to compute corridor losses, which provide a measure for the extent to which a trial crown shape positioned at a location in the dentition is within the boundaries of a 3D space defined by dental arches. For example, collisions losses may be computed based on point-to-surface distance as described in the article of Engelmann et al, From points to multi-object 3D reconstruction, https://arxiv.org/abs/2012.11575v3, which is hereby incorporated by reference into this application. Similarly, corridor losses may be computed based on the distance between anatomical landmarks of the trial crown shape to the lines defining the different dental arches.

Different machine learning models may be used in the scheme as illustrated in FIG. 6. These machine learning models have in common that they are trained to produce a trial crown shape based on one or more shape parameters that may be provided to the input of the machine learning model and that they are associated with a loss function that may compute a loss value that provides a measure how well a trial crown shape meets the 3D constraints.

In an embodiment, the machine learning model may use a so-called signed distance function as a 3D shape description for crown shapes. In an embodiment, the machine learning model may be as a so-called decoder model, which is trained for crown shapes in a low-dimensional latent space in which many crown shapes can be efficiently embedded. For example, in an embodiment, a continuous signed distance function (SDF) may be used to represent classes of crown shapes. An SDF may represent a surface of a crown shape by a continuous volumetric field in which a point in the field represents a distance to the surface boundary wherein the sign indicates whether the region is inside or outside of the chape.

An example of such decoder model is described in the article by Jeong Joon Park et. Al, DeepSDF: learning continuous signed distance functions for shape representation, https://arxiv.org/abs/1901.05103, which is hereby incorporated by reference in this application. Various other SDF-based machine learning models for efficiently generating crown shapes may be used including but not limited to the Local Geometry Code Learning (LGCL) model as described in the article by Yao et al, 3D Shapes Local Geometry Codes Learning with SDF, arXiv:2108.08593, or the Deep Local Shapes (DeepLS) model as described in the article by Chabra et al, Deep Local Shapes: Learning Local SDF Priors for Detailed 3D Reconstruction, arXiv:2003.10983 which both improve the DeepSDF model by learning from a local shape geometry of the full 3D shape. A further SDF model that may be used is described in the article by Mu et al, A-SDF, Learning Disentangled Signed Distance Functions for Articulated Shape Representation arXiv:2104.07645. The content of these articles are herewith incorporated by reference into this application.

To train the decoder model, a set of latent codes may be linked with different training crown shapes (represented in SDF format). This way, the auto-decoder will learn to generate different SDF-encoded crown shapes for different latent codes 608 at the input. The model may comprise a fully connected network having a input 604 for receiving coordinates (x,y,z) of a crown shape and an input 608 for receiving a latent code associated with the crown shape. During training the network computes estimated SDF values associated with the coordinates and a loss function is used to penalize deviations of the prediction of the SDF values by the network from the actual SDF values of a target. During inference, the trained auto-decoder model will provide a crown shape in encoded form, for example a set of SDF values, in response to a latent code (a vector) that is provided to the input of the auto-encoder model.

Once trained the auto-encoder model may be used to generate a crown shape using the latent code as a shape optimization parameter. Thus, starting with an initial latent code (an initial shape parameter) provided to the input of the auto-decoder model a set of SDF values representing a trial crown shape (an SDF encoded train crown shape) will be provided at the output of the model. The trial crown shape is an estimate of crown shape that is associated with the initial latent code. In an embodiment, the initial latent code may be determined based on an average value of the latent codes of a set of crown shapes of a certain tooth type (e.g. FDI). In an embodiment, the set of basic crown shapes as described above may be used for determining such average value.

To compute losses based on the crown shape in the real space, the SDF-encode trail crown shape may be transformed using a suitable transformation algorithm 614 into a mesh representation of a crown shape. For example, in an embodiment, the MeshSDF algorithm may be used to transform an SDF representation of the crown shape to a mesh representation of a crown shape. The MeshSDF algorithm is described in the article by Remelli et al, MeshSDF: differential iso-surface extraction, arXiv:2006.03997, which is hereby incorporated by references. This crown shape may then be used as the trial crown shape that is optimized using the optimization process as depicted in FIG. 6. For example, a marching cubes algorithm may be used to transform the SDF representation of the crown shape into a mesh representation of the trial crown shape 616. The coded auto-decoder model provides an efficient way of encoding a plurality of different crown shapes represented by points in the real space into a low dimensional latent space. It is noted that the embodiments are not limited to the model as illustrated in FIG. 6 other models that are suitable for the shape optimization scheme of FIGS. 5 and 6.

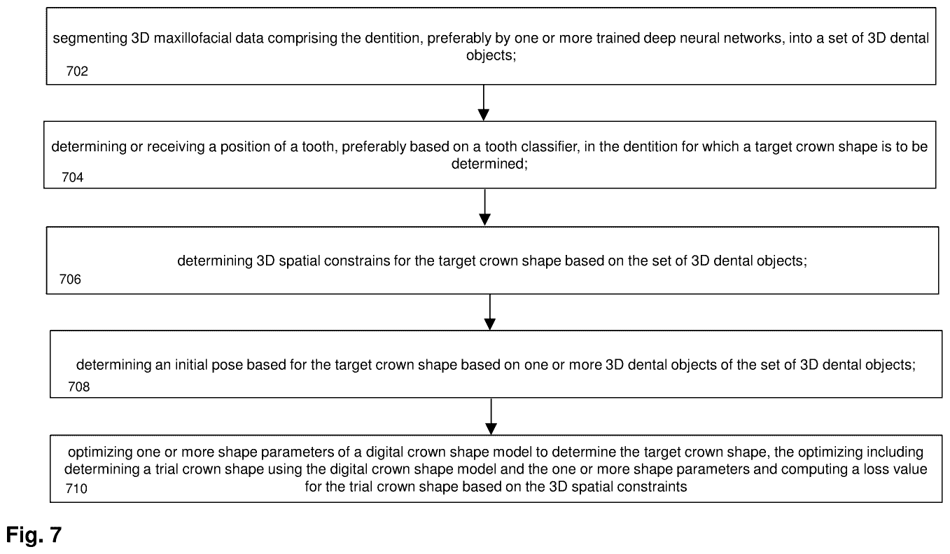

Hence, as explained above, the embodiments relate to a computer-implemented method for automatic generation of a crown shape for a dentition. This method is illustrated in the flow diagram of FIG. 7. The method may include the steps of segmenting 3D maxillofacial data comprising the dentition, preferably by one or more trained deep neural networks, into a set of 3D dental objects (step 702). In a further step,

a position of a tooth in the dentition for which a target crown shape is to be determined may be received or determined (step 704). Further, in step 706 3D spatial constraints for the target crown shape may be determined based on the set of 3D dental objects. An initial pose based for the target crown shape may be determined based on one or more 3D dental objects of the set of 3D dental objects (step 708). Then, one or more shape parameters of a digital crown shape model may be optimized to determine the target crown shape. Here, the optimizing may include determining a trial crown shape using the digital crown shape model and the one or more shape parameters, computing a loss value for the trial crown shape based on the 3D spatial constraints and the initial pose (step 710). If the loss value does not meet one or more optimization conditions modifying the one or more shape parameters to determine a further trial crown shape and to compute a further loss value (step 712). The method allows automatic design of a crown shape based on 3D maxillofacial data comprising the dentition. Only a model of a crown shape needs to be optimized, while the 3D constraints associated with the other teeth in the dentation can be processed using a loss function.

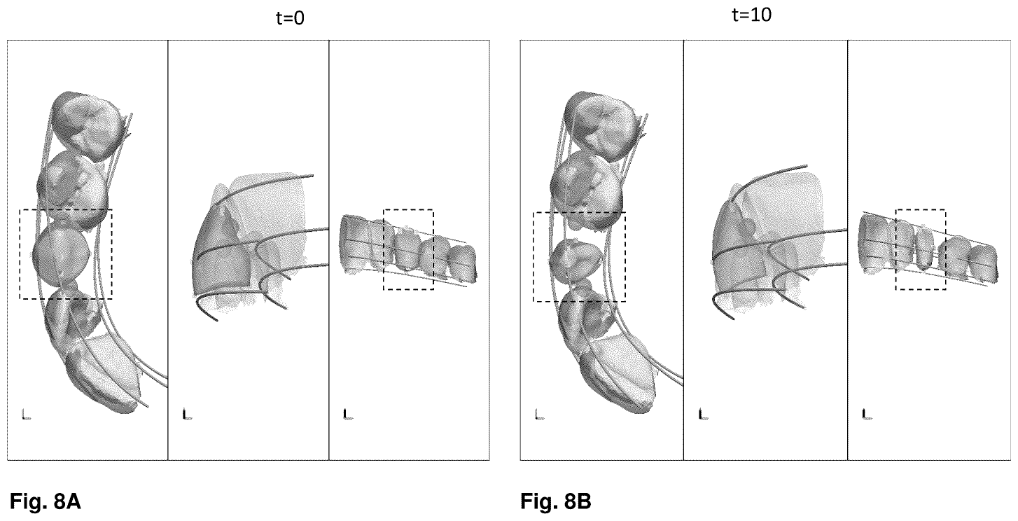

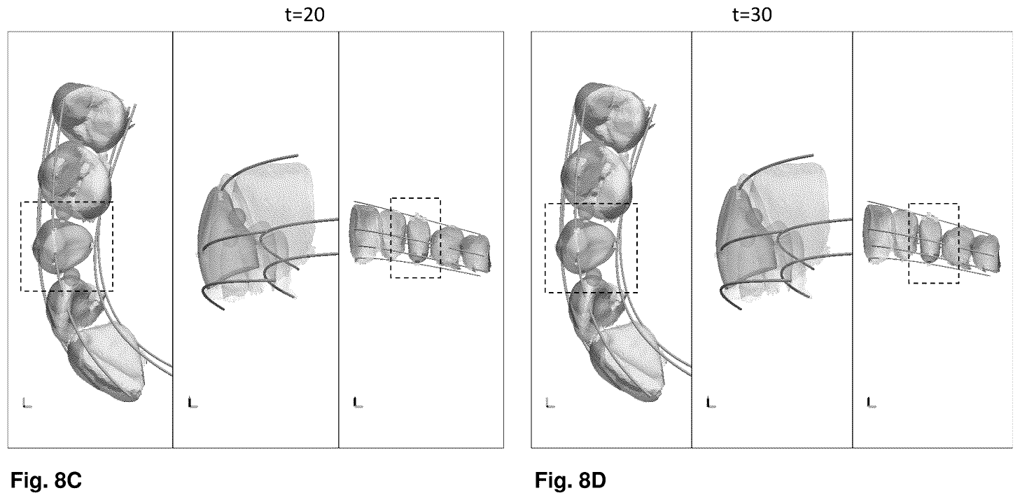

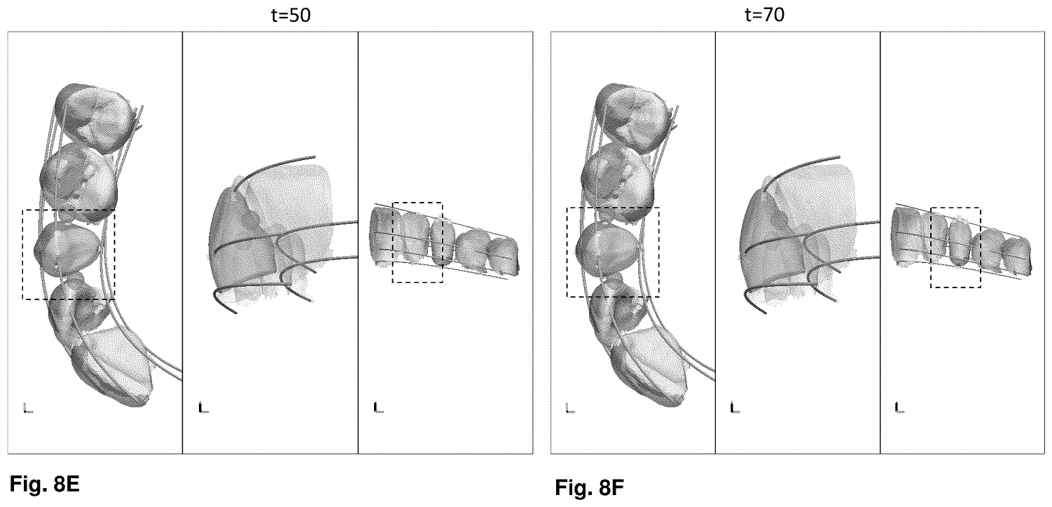

FIG. 8A-8F depict the evolution of a tooth shape during the optimization process according to an embodiment. FIG. 8A depicts part of a dentition comprising teeth of a patient and (in the dotted box) a tooth that needs to be modelled. As shown in this figure, the first trial crown shape shows some overlap with neighboring teeth as well as part of the 3D dental arches. Based computed loss value this trial box model will be disapproved and a further optimization round is needed. FIG. 8B show the trial function of the next round. As shown in this picture, the dimensions of the crown shape are substantially reduced, however in this case a little too much as there is large space between the crown mode and the neighboring teeth. This process may be repeated several times (FIG. 8C-8E), each time producing a different crown shape that provide lower loss values unit an optimization condition, e.g. no significant decrease in the loss value, is met (following the scheme as described with reference to FIG. 5). The end results in FIG. 8F is a crown shape that optimally fits in the space between the teeth taken into account the 3D constraints derived from the other teeth of the dentition. The optimized crown shape model may be displayed together with associated 3D tooth models to form a model of a dentition of a patient. The model of the dentition may be used in a digital dental treatment planning application, which is configured to execute digital workflows.

The optimisation of a crown shape as described above with reference to FIG. 1-8 may be used in a crown design workflow of a digital treatment planning application.

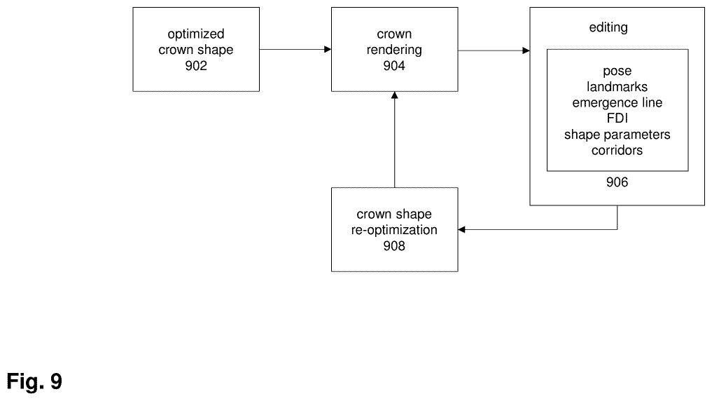

FIG. 9 illustrates an example of user-interactive automatic crown shape generator according to an embodiment. The automatic crown shape generator may be part of a dental workflow allowing a user to interact with the digital crown shape model during the optimization process. This way, the automated crown shape optimization as presented with reference to FIG. 1-8 may be provided with user-guided editing functionality that allows interactive modification of the optimization information that is used during optimization. These optimization information include 3D spatial constraints for the crown that needs to be generated and/or optimization parameters (such as pose, landmarks, emergence lines, and shape-specific features, etc.). User-guided editing functions allow modification of part of the optimization information. The modified optimization information may be used for subsequent re-optimization of the crown shape. This iterative approach ensures the creation of a refined and optimized crown shape that aligns with functional and aesthetic requirements as determined by the constraints.

The process may start with an optimized crown shape 902, which can be determined using one of the optimization methods described in FIG. 5 or FIG. 6, which use a digital crown shape model to generate a crown shape and which are designed to optimize the shape and pose the crown shape, while ensuring a proper fit in a dentition, an within the dental arches, avoiding collisions with neighboring teeth, and adhering to spatial constraints derived from 3D dental data. The result of the optimization process is an optimized crown shape.

The optimized crown shape may be provided to a rendering module 904. The rendering module may be configured to visually display the generated crown shape in a dentition of a patent. The rendering module enabling further evaluation and user-guided interaction with the crown shape model to refine the crown design.

The rendering module may digitally display the crown shape enabling the user to examine the generated crown shape in detail within its dental context, e.g. in model of a dentition of a patient, and may provide real-time feedback on its integration with the surrounding dentition. Further, the rendering module may allow for visualizations of crown adjustments during the user-guided editing process, so that the user may evaluate the optimized crown shape and effectively add refinements of the crown shape in real-time.

To that end, an editing module 906 may be configured to allow a user to modify part of the optimization information that is used during the optimization process. For example, the editing module may be configured to generate a graphical user interface (GUI) which is configured to receive user input allowing the user to modify aspects of the crown shape (optimisation variables), such as its pose, tooth label according to the FDI numbering, anatomical landmark points, emergence line, shape parameters, or dental corridors. The modifications may be performed interactively via the GUI and after modification of the parameters, the optimization information that is used during optimization may be updated based on the user input.

The optimization module 908 may then re-optimize the crown shape model based on the modified optimization information. A new crown shape is automatically generated by incorporating the user's edits as updated optimization information in to the digital crown shape model, such as revised constraints or modified shape and pose parameters. The updated optimization information may be processed through the same digital crown shape model that was employed to automatically generate the initial, unedited optimized crown shape ensuring consistency in the optimization approach while reflecting the user's modifications.

These inputs are used to guide the optimization process while ensuring compliance with the 3D spatial constraints and clinical requirements established during the original (i.e. before the editing) optimization process of the digital crown shape model. The newly re-optimized crown shape may be sent back to the rendering module for further evaluation, completing the iterative refinement cycle.

The feedback loop of rendering an automatically generated crown shape based on a crown shape optimization scheme, the modification of optimization information (e.g. optimization parameters and/or constraints) and the subsequent re-optimization of the crown shape based on the modified optimization information enable the user to efficiently and accurately refine the crown shape to meet specific requirements, including 3D spatial constraints and constraints related to the pose of the crown shape.

The workflow integrates automated crown shape generation with an intuitive, guided human-machine interaction process, enabling the efficient creation of high-quality, customized crown shapes. By applying optimization techniques and incorporating real-time user feedback, the system produces crown shapes that satisfy specific clinical constraints and spatial requirements.

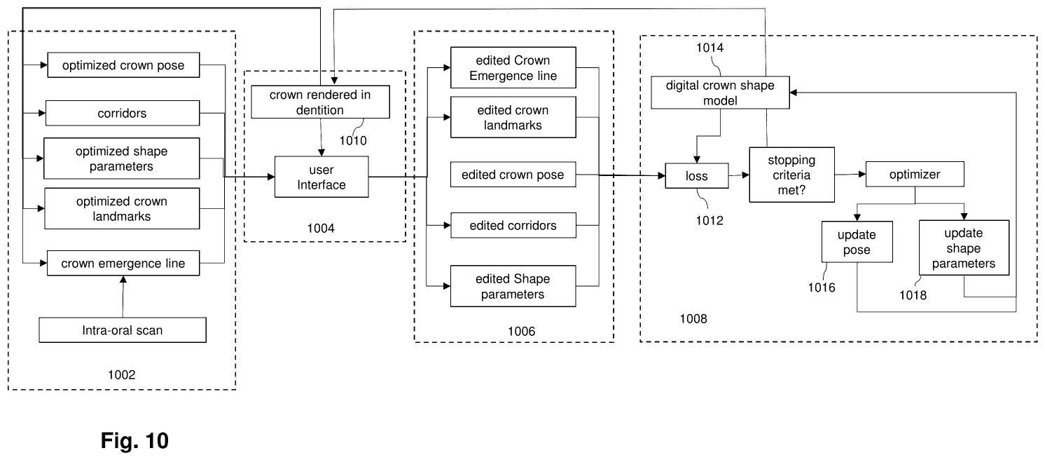

FIG. 10 illustrates schematic of a process for generating, editing, and optimizing a crown shape according to an embodiment. through a multi-phase approach that integrates automated generation of a crown shape 1002, user interaction 1006, and iterative refinement of the crown shape 1008. The process may be divided into three distinct modules: an initial optimization module, a user-driven editing module, and a re-optimization module.

The process may start with a first phase 1002, which serves as an initialization for the crown shape generation process. This module may utilize an crown shape model, such as those described with reference to FIG. 5 or FIG. 6, to automatically generate an initial optimized crown shape. This optimized crown shape is associate with certain values of the optimization parameters such as the crown pose and/or crown shape parameters. Further information that was used during the optimization such as the crown pose, anatomical landmarks, dental corridors, tooth numbering, crown emergence line, and shape parameters derived from 3D dental data, such as intra-oral scans may be stored and form the initial values for the subsequent user-guided re-optimization process. The initialization step ensures that the crown shape aligns with the patient's unique dental anatomy and adheres to predefined spatial constraints, creating a clinically viable starting point for further customization and optimization (i.e. a crown rendered in dentition, 1010).

In the second phase 1004, the optimized crown shape may be displayed as part of the dentition and may be displayed together with a user interface. This visual representation allows the user to evaluate the crown's fit and alignment within the dental arches and its relationship to neighboring teeth. The user interface enables real-time interaction, allowing the user to edit and refine the automatically generated crown shape based on editable optimisation variables.

In a third phase 1006, the user can modify the crown shape by editing a set of optimisation variables. The editable optimisation variables may include the crown emergence line, crown landmarks, crown pose, dental corridors, and/or shape parameters. These modifications may be performed interactively, through the user interface, which provides continuous visual feedback to reflect the changes in real time. This feedback mechanism enables the user to intuitively and efficiently adjust the crown shape to meet specific constrains, given by the edited optimisation variables.

Once the user has completed a set of modifications (i.e. edited a set of editable optimisation variables), the updated parameters are processed in a fourth phase 1008 in which an updated crown shape is generated by optimization of the crown shape using the updated information. In this stage, the updated parameters, including any changes to the tooth shape parameters or pose, are used in the optimization process.

In one embodiment, the same digital crown shape model that was used to generate the initial crown shape may be used to generate and optimize the updated crown shape based on the updated design parameters. These updated design parameters may represent revised 3D spatial constraints and may be incorporated into the loss function to guide the optimization process of the digital crown shape model.

A loss function 1012 evaluates the fit of the updated crown shape by calculating how well it adheres to spatial and clinical constraints given by the edited parameters, such as 3D spatial constraints (e.g. emergence line, crown landmark points, pose, dental corridors) and the initial pose, as further described in FIG. 5, 502. If the computed loss indicates that the newly generated crown shape does not sufficiently meet the required spatial and clinical standards, an optimizer adjusts the shape parameters in the optimization process.

In some embodiments, the optimizer may also update the pose 1016 of the newly generated crown shape in addition to modifying the shape parameters 1018. Optimization algorithms such as stochastic gradient descent (SGD) or Adam may be utilized to adjust the I parameters of the crown shape model iteratively. The updated pose is then factored into the loss computation to ensure alignment with the required constraints.

The process of modifying shape parameters, optionally updating the pose, generating a new crown shape model, and recomputing the loss may repeat until the optimization conditions are satisfied. These conditions may include meeting a predefined loss threshold, reaching an early stopping criterion, or completing a maximum number of iterations. Once the optimization is complete, the newly generated crown shape is rendered 1010 alongside the other 3D dental objects derived from the maxillofacial data, ensuring that the final crown shape is anatomically accurate, while complying with the manually updated optimisation variables.

Once the optimization is complete, the final re-optimized crown model is returned to the rendering module for evaluation, completing the iterative cycle.

The process depicted in FIG. 10 represents an integrated approach to crown design, combining automated optimization, guided user interaction, and iterative refinement. This ensures that the final crown shape is both anatomically accurate and customized to the specific needs of the patient or clinician.

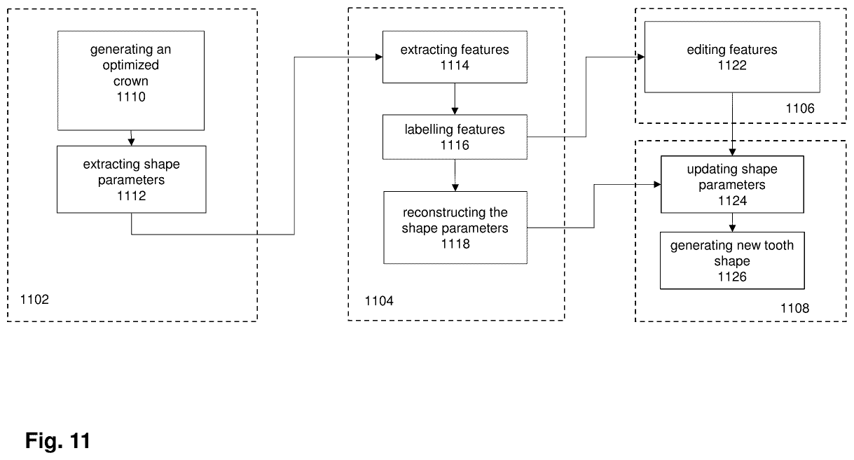

FIG. 11 illustrates a process for generating, editing, and refining a digital crown shape model through user interaction according to another embodiment. The editing and refining of the digital shape model is realized by allowing the user to edit the shape parameters of a digital crown shape model by a number of graphical user interfaces (GUIs). Unlike directly interpretable parameters such as landmark points, tooth numbering, dental corridors, pose, etc. that were discussed with reference to FIG. 9 and FIG. 10, these shape parameters are inherently abstract, as they may represent either a latent code in a reduced-dimensional space (reference to FIG. 6) or vertices of basic crown shapes that collectively define the crown's geometry (reference to FIG. 5). Due to their abstract nature, the shape parameters cannot be directly edited by the user. For this reason, a feature extraction and labelling process may be introduced to identify interpretable variations in the crown shape model's geometry and make them accessible for user-driven editing.

In a first phase 1102, an optimized crown shape is generated and the information associated with the optimized crown shape is used for initializing the editing 1106 and optimization 1108 of the model's shape parameters. These shape parameters may encode geometric and/or structural features of the crown shape and may be represented as either a compact latent code, abstractly defining the shape, or the vertices of basic crown shapes that explicitly describe the model's geometry. Regardless of the representation, the shape parameters define geometric and/or structural features of the digital crown shape model, being used for crown shape generation as well as enabling precise manual editing and customized optimization.

In a second phase 1104, the shape parameters may be processed through a feature extraction 1114 and labeling process 1116 that transforms them into a more interpretable and user-friendly representation. This process isolates the most significant variations within the shape parameters, enabling the identification of key factors that govern the crown's shape geometry and/or aesthetics.

For latent code-based models, the transformation disentangles the encoded space, identifying variations that correspond to meaningful geometric or structural attributes of the crown, such as changes in width, height, or curvature. For vertex-based representations, the process may detect variations in the spatial configuration of the vertices that define the overall geometry of the crown, including refinements to surface contours, adjustments to cusp positions, and modifications to other anatomical features.

Once these variations are identified, the extracted features are assigned semantic labels, creating a bridge between the abstract parameter space and user-interpretable concepts. These labels may correspond to recognizable crown characteristics, such as crown size, cusp sharpness, curvature, surface texture, or tooth wear, etc. The labelling process can be performed manually, where domain experts inspect the variations and assign meaningful descriptors based on their clinical or aesthetic significance. Alternatively, it can be automated using machine learning techniques, where the system analyses the variations and correlates them with predefined attributes or patterns learned from training data. By assigning these semantic labels to extracted features, whether manually or automatically, users may be provided with a clear and intuitive way to understand and precisely adjust specific shape parameters of the digital crown shape model, such as its size, curvature, or surface texture.

This feature extraction 1114 and labeling process 1116 not only enhances user interaction but also ensures that the parameters retain their connection to the original anatomical and spatial constraints of the generated crown shape. Hence, the feature extraction and labelling process transforms abstract or high-dimensional shape parameters into a more interpretable form while preserving the underlying structure and constraints essential for maintaining the generated crown shape accuracy.

During the editing phase 1106, labelled features 1116 may be presented to the user through an interactive interface. Users may modify specific features of the crown shape by adjusting one or more of the extracted and labelled features using tools such as sliders or buttons. For example, users may increase the crown's width, sharpen its cusps, refine the smoothness of its surface, or adjust features such as age, wear, and texture. To ensure meaningful and effective interaction, only a selected subset of the labelled features is made available for editing.

In a third phase 1108, the updated shape parameters, modified based on extracted features and the user input, are utilized to regenerate the shape model parameters 1124. The process of generating updated shape parameters integrates the user-defined modifications directly into the digital crown shape model, producing a revised version of the shape parameters that reflects the specified user edits while preserving the learned relationships and constraints established during the training of the digital crown shape model.

The method used for generating updated shape parameters 1124 may depend on the representation of the shape parameters. In an embodiment, if the parameters are represented as a latent code, the updated latent code may be processed by the underlying shape model (e.g., a neural network or similar generative model) to decode the edited one or more shape parameters. For vertex-based representations in another embodiment, the edited shape parameters directly update the positions of the vertices, directly reshaping the crown's geometry. In both cases, if updated shape parameters fail to meet the predefined constraints (e.g., 3D spatial constrains causing misalignment or collisions), iterative optimization may be employed to further refine the pose or alignment. Therefore, by integrating user-defined modifications into the parameterized shape representation while preserving the learned constraints, the system ensures that the generated crown shape after the editing 1126 remains anatomically and clinically valid.

In one embodiment, a vertex-based linear model may be employed to represent the crown shape as a weighted combination of predefined basic crown shapes, as further described in FIG. 5. In this embodiment, the digital crown shape model may be mathematically expressed as:

$${S}_{FDI} = W \cdot {V}_{FDI} ,$$

where S_{FDI} denotes the crown shape for a specific FDI classification, W represents the weights applied to the N basic crown shapes, and V_{FDI} contains the vertex data of the basic crown shapes that collectively define the geometry.

To simplify this representation, feature extraction 1114, such as Principal Component Analysis (PCA), may be applied to transform the model into:

$${S}_{FDI} = {W}_{p} \cdot {C}_{FDI}$$

In this form, Wₚ contains the weights for a reduced number of principal components R, while C_{FDI} represents the principal components that encapsulate the dominant modes of variation in the crown shape. This approach allows user adjustments to Wₚ, enabling editing of specific, interpretable crown shape parameters, such as crown size, curvature, crown age, crown wear, etc., representing the labelled features 1116, while maintaining consistency with the underlying representation of the digital crown shape model.

In another embodiment, other feature extraction methods may be employed, such as auto-encoders, wherein the high-dimensional vertex data of the crown shape V_{FDI} is encoded into a lower-dimensional latent representation, C_{FDI}.

In a second embodiment, a generative neural network such as a DeepSDF-based model may be used to generate a crown shape, as further explained in FIG. 6. In this embodiment, the digital crown shape model may be formally represented as:

S_{FDI}=F(L)

where F is the generative neural network such as DeepSDF, generating the crown shape, and L is a latent code encoding the crown shape. Similarly, feature extraction, such as PCA, may be applied to the latent code, resulting in the transformed latent code representation:

$${L}_{FDI}^{*} = {W}_{p} \cdot {C}_{FDI}$$

In this form, Wₚ contains the weights for the principal components, and C_{FDI} represents the principal components within the latent code, derived from the training data for a specific tooth number based on the FDI classification. The transformed latent code L_{FDI}* may be further used to represent the digital crown shape model as:

S_{FDI}=F(L_{FDI}*)

Thus, this embodiment enables the user to edit Wₚ to control crown shape parameters (given by the extracted 1114 and labelled features 1116), such as cusp sharpness or surface texture, tooth age, tooth wear, etc. while ensuring that the generated crown shape complies with anatomical and spatial constraints given by the trained digital crown shape model, as well as the 3D spatial constraints and/or pose constraints.

In another embodiment, other feature extraction methods may be employed, such as auto-encoders, wherein the shape parameters space (latent code) is encoded into a lower-dimensional latent representation, C_{FDI}, using the latent codes learned during the digital crown shape model training. The used latent codes may correspond to specific tooth categories, based on the FDI classification.

To ensure the generated crown shape satisfies the 3D spatial constraints and the pose constraints, Wₚ may be iteratively optimized. The optimization process adjusts Wₚ to minimize a loss function that evaluates the generated crown shape compliance with special constraints such as pose and 3D spatial constraints (further discussed in FIG. 1 and FIG. 4).

Once the optimization achieves a desired optimization condition (loss value, iteration limit, early stopping, etc), the refined Wₚ provides a latent code representation of the crown shape that satisfies the 3D spatial and pose constraints while preserving the representation of the digital crown shape model.

Following this optimization, the system may enable user interaction by allowing manual adjustments to Wₚ. In this embodiment, the extracted features (1114, C_{FDI}) are labelled by analysing the effect of each principal component on the generated crown shape. This is achieved by systematically varying the weights in Wₚ for each principal component and observing the resulting changes in the crown shape generated by the generative model. Domain experts may inspect these variations to identify specific visual or geometric attributes influenced by each component, such as cusp sharpness, crown size, tooth wear, tooth age, surface texture, curvature, etc. Once these attributes are identified, the principal components are assigned semantic labels 1216 that reflect their corresponding features. These labels make the otherwise abstract principal components interpretable and editable for the user, enabling intuitive customization of the crown shape parameters.

After user interaction, the adjusted Wₚ is used to regenerate the crown shape, using the same inference process as further described in FIG. 6.

Both embodiments, presenting different crown shape models, maintain the integrity of the underlying constraints and crown shape model, ensuring that the generated crown shape designs remain anatomically accurate and functionally viable, while allowing for user-driven customization through the editing of labelled features.

FIG. 13-15 illustrate graphical user interfaces GUIs of the workflow a described above with reference to FIG. 9-11. The GUIs may be generally divided into three parts: GUIs for the initial crown shape generation, GUIs for user-driven optimisation variablesediting, and GUIs for rendering the updated, generated crown shape. The GUIs enable the user to interact with and edit specific optimisation variables of the crown shape, ensuring that both clinical and aesthetic requirements are met.

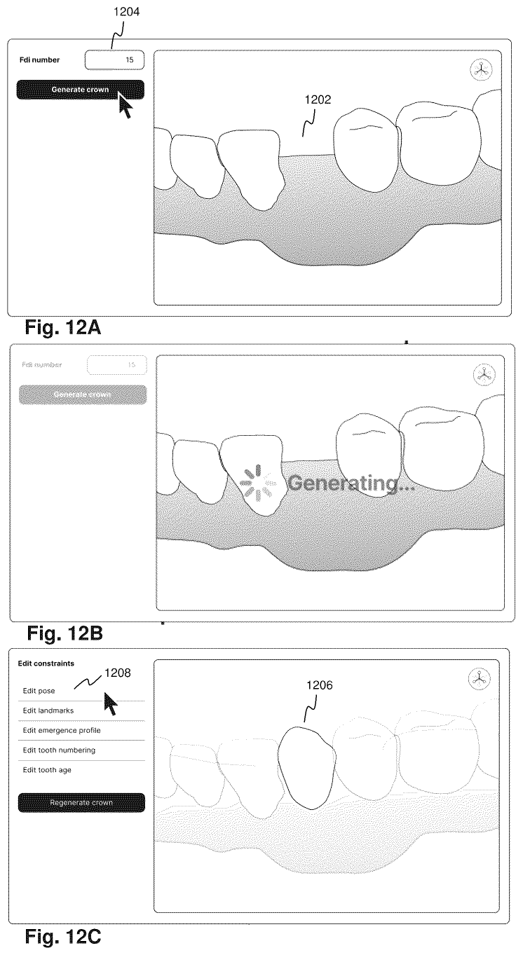

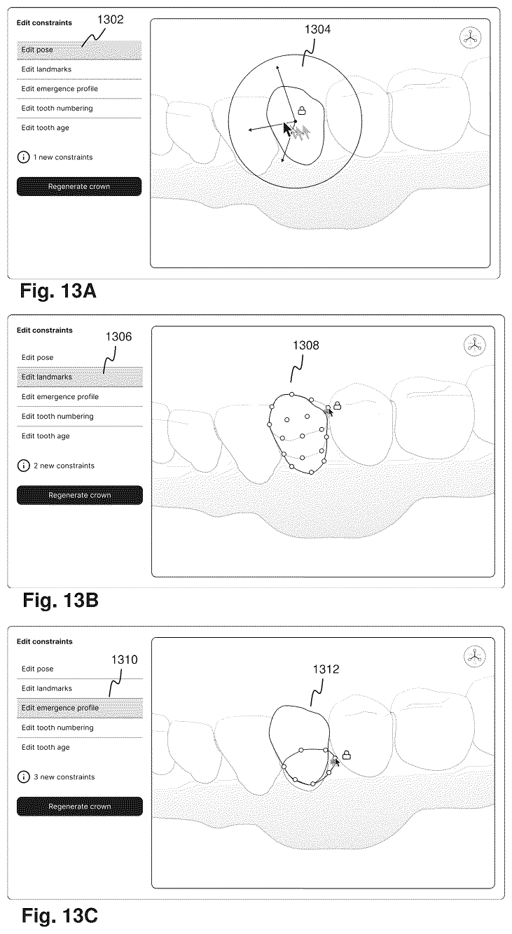

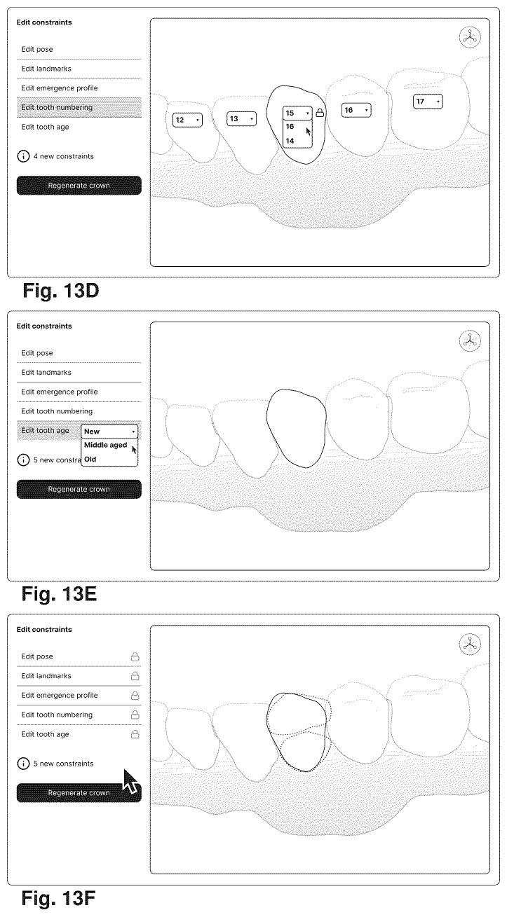

FIG. 12A-12C illustrate GUIs for the initial crown shape generation according to an embodiment. The GUIs allows the user to generate the initial optimized crown shape based on constraints derived from 3D dental data, as explained with reference to the optimization process presented in FIG. 5 or FIG. 6.

As shown in FIG. 12A a first GUI may allow user may initiate the crown generation process via one or more buttons. As shown the figure part of a dentition of a patient may be displayed, wherein the dentition shows a location 1202 of a missing tooth. The first GUI may include one or more user input fields 1204, which the user may be used to set some of the optimization variables. For example, the GUI may also a user to select the FDI number of the missing tooth. Further, the first GUI may include a user input to execute the optimization process based on optimizing a crown shape generated by a parameterized digital crown shape model as described with reference to FIGS. 5 and 6.

After executing crown shape optimization process, the crown shape that is generated is displayed in the dentition at the location of the missing tooth as shown in FIG. 12C. A GUI may be displayed that is configured to receive user input associated with one or more optimization variables which affect the crown design. Once the initial crown shape is generated, it is rendered within the interface for evaluation, providing a baseline crown shape for subsequent refinements.

FIG. 13A-13F illustrate GUIs for user-driven optimisation variables editing according to an embodiment.

These GUIs are configured for user-driven editing of the optimisation variables, where the user interface enables modifications to specific aspects of the crown comprising 3D spatial constraints, pose, shape parameters. Each editable design parameter may be displayed as a selectable option in the interface, such as crown pose, anatomical landmarks, emergence profile, tooth numbering, and tooth age, etc. Selecting one of these options allows the user to access detailed controls for modifying that parameter. For example, editing the pose, users can adjust the spatial position and orientation of the crown, including its translation, rotation, or alignment within the dental arch. Each modification may be performed through interactive tools, such as sliders, buttons, or drag-and-drop mechanisms, which provide real-time visual feedback as the adjustments are applied.

FIG. 13A illustrates an example of a GUI which is configured to receive user input regarding pose modification. This interface allows the user to interactively adjust the position and orientation of the crown within the dental arch. On the left panel, the user may select the “Edit pose” option from a list of editable optimisation variables, which also may include landmarks, emergence profile, tooth numbering, and tooth age, etc. Once selected, tools for modifying the crown's pose are activated.

In the main visualization area, the crown shape being edited is highlighted, and interactive controls are displayed. These controls include arrows and rotation handles, which represent the three-dimensional axes of movement. The user can adjust the crown's position by translating it along the indicated axes or modify its orientation by rotating it about these axes. For instance, moving the cursor and dragging an arrow shifts the crown in the corresponding direction, while manipulating the circular handles adjusts the rotation. A lock icon is displayed to indicate that specific degrees of freedom or constraints may be fixed or restricted.

The interface may also include a “Regenerate crown” button, enabling the user to apply the pose modifications and trigger the system to generate the updated crown shape and refine its placement based on the adjusted pose.

FIG. 13B illustrates an example of a GUI which is configured to receive user input for modifying landmarks. The user may select the “Edit landmarks” option from the list of editable optimisation variables displayed in the left panel. This activates tools for adjusting anatomical landmarks on the crown surface.

In the main visualization area, the crown is highlighted, and its surface is overlaid with control points representing anatomical landmarks, such as cusp tips or ridge points. The user can drag these points to modify their positions, altering the crown's shape to better fit the dental arch or meet aesthetic and functional requirements. After completing the editing, the user can click the “Regenerate crown” button to update the crown's shape based on the edited landmark positions.

FIG. 13C illustrates an example of a GUI which is configured to receive user input for emergence profile modification. The user may select the “Edit emergence profile” option from the list of editable design parameters on the left panel, enabling tools for adjusting the transition between the crown and the gingival margin.

In the main visualization area, the crown's emergence profile is represented by a set of control points outlining its base. The user can edit these points by dragging them to reshape the profile, ensuring a smooth and natural transition between the crown and the gingiva. For example, the user might adjust the contour to improve the crown's fit within the gingival margin or to achieve a more esthetic integration with the adjacent teeth.

After completing the adjustments, the user can click the “Regenerate crown” button to update the crown's shape, incorporating the modified emergence profile.

FIG. 13D illustrates an example of a GUI which is configured to receive user input for tooth numbering modification. The user may select the “Edit tooth numbering” option from the list of editable design parameters in the left panel, activating controls to adjust the assigned numbering for the crown.

In the main visualization area, each tooth in the arch is displayed with its current numbering, following a standardized dental classification system such as the Federation Dentaire Internationale (FDI) system. The crown being edited is highlighted, and its numbering is shown in a dropdown menu. The user can modify the assigned number by selecting a different option from the dropdown. For instance, the user may change the crown's designation from tooth 15 to tooth 16 to correctly align it with its intended position in the dental arch.

Once the adjustments are complete, the user may click the “Regenerate crown” button to incorporate the updated tooth numbering into the constraints of the digital crown shape model and update the generated crown shape accordingly.

FIG. 13E illustrates an example of a GUI which is configured to receive user input for tooth age modification, based on the optimization of tooth shape parameters. The user selects the “Edit tooth age” option from the editable design parameters displayed in the left panel, activating tools to adjust for example age-related characteristics (derived as a labelled feature, as further explained in FIG. 11).

In the main visualization area, the crown is rendered, and a dropdown menu may allow the user to select from predefined age categories, such as “New,” “Middle-aged,” or “Old.” These categories could be obtained from a feature extraction process applied to the shape parameters od the digital crown shape model, using a method described in FIG. 11. In the feature extraction process variations in the shape parameters that correspond to age-related characteristics may be identified and labelled, enabling user interaction with this labelled feature. For example, selecting “Old” may adjust the crown shape to reflect flattened cusps and smoother surfaces indicative of natural wear over time, while “New” may generate sharper cusps and more defined grooves characteristic of a younger tooth.

FIG. 13F illustrates the interface after multiple editable design parameters have been selected and the “Regenerate crown” button has been pressed. The left-hand panel may show that all editable constraints, such as “Edit pose,” “Edit landmarks,” “Edit emergence profile,” “Edit tooth numbering,” and “Edit tooth age,” are now locked, indicating that user interaction is temporarily disabled during the crown shape generation process.

The main display shows the crown shape being updated, with the dashed outlines representing the transformation in progress. These outlines indicate the intermediate changes to the crown's shape and alignment as the system recalculates the crown shape to incorporate the newly defined design parameters. This regeneration process integrates all the selected constraints into the generated crown shape, ensuring the updated crown shape adheres to clinical and anatomical requirements.

Once the new crown shape is generated, the updated crown shape will be rendered, and the editable design parameters will become available for further adjustments.

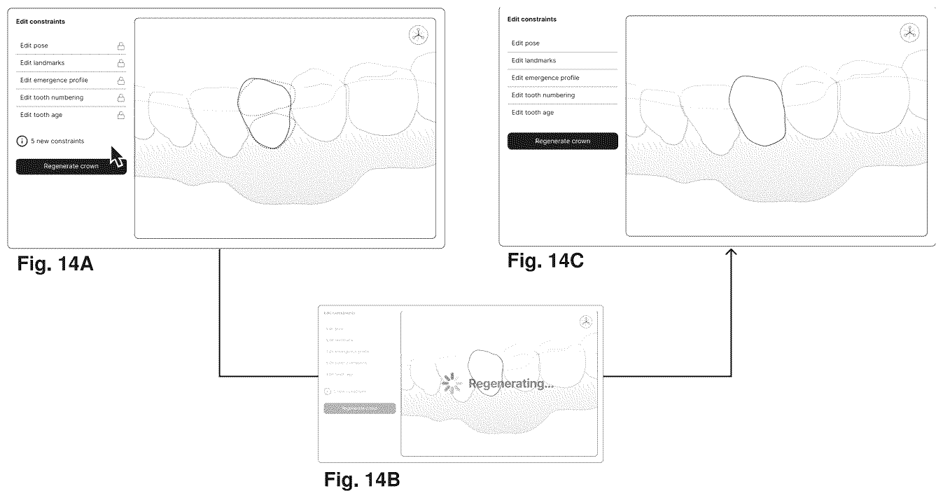

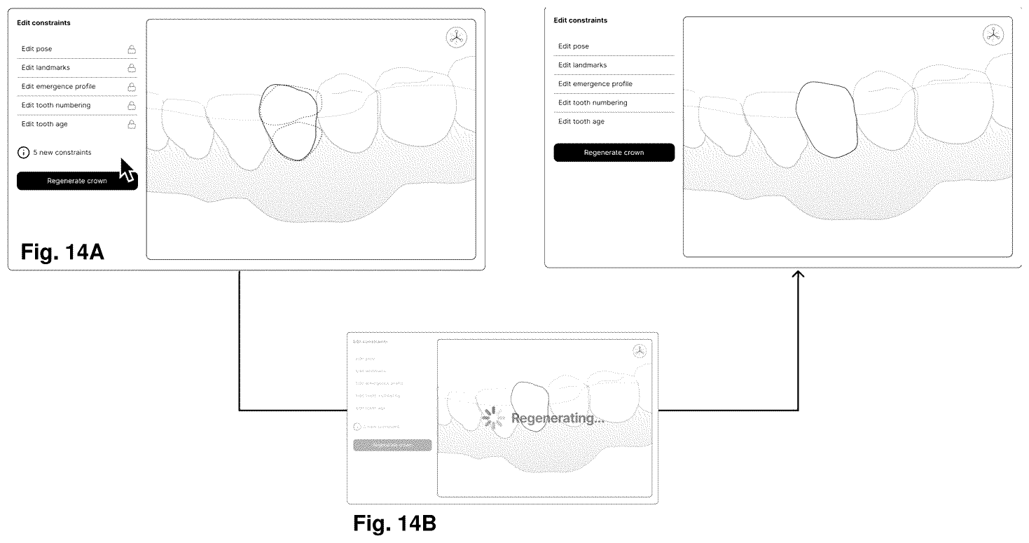

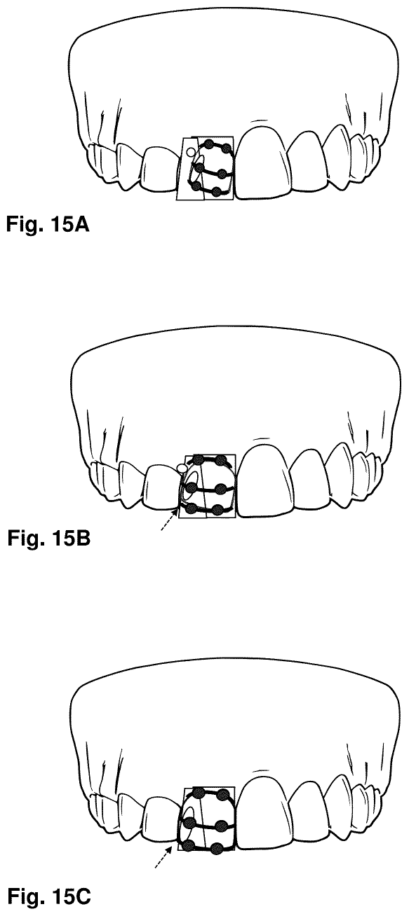

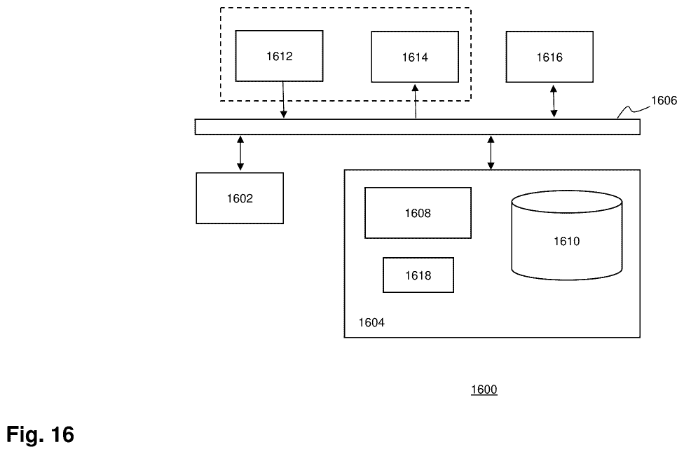

FIG. 14A-14C illustrate GUIs for rendering the updated, generated crown shape. There GUIs replate to execution and rendering the updated crown shape. After the user modifies one or more optimisation variables, the system regenerates the crown based on the updated parameters. The regeneration process ensures that the new crown shape adheres to the adjusted spatial constraints while maintaining anatomical accuracy and spatial consistency. The updated crown shape is then displayed, allowing the user to evaluate the crown shape and make further modifications if needed.

FIG. 15A-15C illustrate a process of previewing and re-optimizing a digital crown shape after user modifications to optimization information. FIG. 15A shows the generated crown shape displayed in the graphical user interface (GUI) prior to any user modifications. FIG. 15B depicts a preliminary preview of the crown shape generated after user modifications to the optimization information. The preliminary preview may use approximate transformations to align the crown shape with the edited constraints without performing a full re-optimization. FIG. 15C illustrates the crown shape after the re-optimization step, where the crown shape is re-optimized using an optimization method as further described with reference to FIG. 10 or FIG. 11.

In one embodiment, the system provides a method for generating a preliminary preview of a digital crown shape as shown in FIG. 15B after the user modifies the optimization information, without performing a full re-optimization. This method enhances the user experience by enabling immediate feedback on the effects of edits, facilitating more intuitive and efficient adjustments. The intermediate preview may be generated using non-trained model-based transformations, ensuring rapid visualization while maintaining a distinction between the preliminary and fully re-optimized crown shape.

When the user modifies optimization information such as crown pose, one or more landmarks, the emergence line, or other crown shape parameters, a preview may be generated that approximates the alignment of the crown shape to the modified optimization information. The preview does not alter the actual shape parameters or perform a re-optimization. Instead, basic transformations are applied to visually adapt the crown shape to the modified optimization information. These transformations may include affine transformations, uniform scaling, or bounding box adjustments.

For example, in an embodiment, an affine transformation may be used to scale the crown shape proportionally along one or more dimensions, based on the relative change in size of the edited optimization information (e.g. a landmark point, pose, etc.). Similarly, in an embodiment, an aspect ratio preservation techniques can be applied to uniformly scale the crown shape using a single scaling factor derived from the ratio of the modified and initial values of the optimization information. Alternatively, in an embodiment, a bounding box constraint may be used to scale the crown shape proportionally to fit a bounding box defined by the modified optimization information. These techniques enable the preview to represent the user's modifications in a computationally efficient way while providing a clear visual indication of the resulting changes.

Once the preview is displayed, the user can further refine the optimization information and observe additional updates to the crown shape in real-time. When the user is satisfied with their modifications, they may press a “regenerate” button, triggering a full re-optimization of the crown shape, according to the method further described in FIG. 10 or FIG. 11.

FIG. 16 is a block diagram illustrating exemplary data processing systems described in this disclosure. Data processing system 1600 may include at least one processor 1602 coupled to memory elements 1604 through a system bus 1606. As such, the data processing system may store program code within memory elements 1604. Further, processor 1602 may execute the program code accessed from memory elements 1604 via system bus 1606. In one aspect, data processing system may be implemented as a computer that is suitable for storing and/or executing program code. It should be appreciated, however, that data processing system 1600 may be implemented in the form of any system including a processor and memory that is capable of performing the functions described within this specification.

Memory elements 1604 may include one or more physical memory devices such as, for example, local memory 1608 and one or more bulk storage devices 1610. Local memory may refer to random access memory or other non-persistent memory device(s) generally used during actual execution of the program code. A bulk storage device may be implemented as a hard drive or other persistent data storage device. The processing system 1600 may also include one or more cache memories (not shown) that provide temporary storage of at least some program code in order to reduce the number of times program code must be retrieved from bulk storage device 1610 during execution.

Input/output (I/O) devices depicted as key device 1612 and output device 1614 optionally can be coupled to the data processing system. Examples of key device may include, but are not limited to, for example, a keyboard, a pointing device such as a mouse, or the like. Examples of output device may include, but are not limited to, for example, a monitor or display, speakers, or the like. Key device and/or output device may be coupled to data processing system either directly or through intervening I/O controllers. A network adapter 1616 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Operation modems, cable operation modems, and Ethernet cards are examples of different types of network adapter that may be used with data processing system 1600.

As pictured in FIG. 16, memory elements 1604 may store an application 1618. It should be appreciated that data processing system 1600 may further execute an operating system (not shown) that can facilitate execution of the application. Application, being implemented in the form of executable program code, can be executed by data processing system 1600, e.g., by processor 1602. Responsive to executing application, data processing system may be configured to perform one or more operations to be described herein in further detail.

In one aspect, for example, data processing system 1600 may represent a client data processing system. In that case, application 1618 may represent a client application that, when executed, configures data processing system 1600 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 1618, when executed, may configure data processing system to perform (HTTP) server operations. In another aspect, data processing system may represent a module, unit or function as referred to in this specification.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for automatic generation of a crown shape for a dentition of a crown, the method comprising:
determining an optimized crown shape for a tooth position in the dentition using a digital crown shape model, the digital crown shape model being associated with optimization information, the optimization information including one or more optimization parameters, wherein optimization comprises: generating a trial crown shape using the digital crown shape model; computing a loss value for the trial crown shape based on 3D spatial constraints associated with the dentition and an initial pose of the crown; and iteratively minimizing the loss value by modifying the one or more optimization parameters until one or more optimization conditions are met;
displaying the optimized crown shape at the tooth position within the dentition and a graphical user interface (GUI) associated with the displayed optimized crown shape, the GUI being configured to receive user input for modifying at least part of the optimization information;
in response to user input for modifying the at least part of the optimization information, determining a re-optimized crown shape using the digital crown shape model based on the modified at least part of the optimization information; and;
displaying the optimized crown shape at the tooth position within the dentition.

2. The method according to claim 1 wherein the optimization information presented by the GUI includes at least one of: a crown pose, one or more landmarks, an emergence line, an FDI number, one or more dental corridors, one or more crown shape parameters.

3. The method according to claim 2, wherein the digital crown shape model is defined as a linear combination of different basic crown shapes of a tooth wherein the crown shape parameters represent coefficients associated with each basic crown shape defining at least part of the one or more optimization parameters.

4. The method according to claim 1, wherein the digital crown shape model comprises at least one trained deep neural network, preferably a DeepSDF-based model, that is trained to generate different crown shapes as a function of one or more optimization parameters provided to an input of the at least one trained deep neural network, wherein the optimization parameters control at least a shape of the crown shape.

5. The method according to claim 2, wherein re-optimization of the digital crown shape model after user modification of the optimization information comprises:
receiving one or more modified values corresponding modified optimisation information from the GUI;
computing a loss value based on the modified optimisation information and using the digital crown shape model; and,
minimizing iteratively the loss value by updating the crown shape parameters and/or crown pose parameters until the loss value satisfies one or more optimization conditions.

6. The method according to claim 5, wherein re-optimization of the digital crown shape model after user modification of the crown shape parameters further comprises:
receiving crown shape parameters associated with the optimized crow shape displayed in the GUI;
extracting one or more features from the crown shape parameters, wherein the extraction comprises identifying features that represent variations in the crown shape parameters;
labelling a predefined set of the extracted features;
regenerating the crown shape parameters based on the set of labelled features;
providing a labelled set of features as editable inputs for the GUI; and
using the modified values of the labelled features to further optimize the pose of the crown shape by iteratively minimizing a loss function, wherein the loss function is minimized by updating the crown pose parameters until one or more optimization conditions are satisfied.

7. The method according to claim 6, wherein extracting one or more features from the crown shape parameters comprises: performing principal component analysis (PCA) to reduce dimensionality of a space associated with the crown shape parameters, wherein principal components represent the most significant variations in crown shape geometry.

8. The method according to claim 7, wherein extracting one or more features from the crown shape parameters comprises: using an auto-encoder neural network to reduce the dimensionality of the crown shape parameter space, wherein a latent representation produced by the auto-encoder neural network encodes the most significant geometric and structural variations in the crown shape geometry.

9. The method according to claim 6, wherein labelling the extracted features comprise:
assigning semantic labels to the extracted features, wherein the labels correspond to crown shape characteristics including at least one or more of: a crown size, a cusp sharpness, a curvature, a surface texture, a tooth wear or a tooth age.

10. The method according to claim 9, wherein the assignment of the semantic labels to the extracted features is based on a trained machine learning model that is trained to learn a correlation between the crown shape characteristics and the extracted features.

11. The method according to claim 2, wherein a preview of the digital crown shape is generated after user modification of optimization information, wherein the generation of the preview of the digital crown shape includes:
applying one or more transformations to the crown shape to generate the preview, wherein the one or more transformations adjusts the crown shape to approximate alignment with the modified optimization information without altering the crown shape parameters;
displaying the crown shape preview in the GUI to provide visual feedback of the modifications.

12. A system for automatic generation of a crown shape for a dentition for a crown, the system comprising:
a computer readable storage medium having computer readable program code embodied therewith; and a processor, preferably a microprocessor, coupled to the computer readable storage medium, wherein responsive to executing the computer readable program code, the processor is configured to perform executable operations comprising:
determining an optimized crown shape for a tooth position in the dentition using a digital crown shape model, the digital crown shape model being associated with optimization information, the optimization information including one or more optimization parameters, wherein optimization comprises: generating a trial crown shape using the digital crown shape model; computing a loss value for the trial crown shape based on 3D spatial constraints associated with the dentition and an initial pose of the crown; and iteratively minimizing the loss value by modifying the one or more optimization parameters until one or more optimization conditions are met;
displaying the optimized crown shape at the tooth position within the dentition and a graphical user interface (GUI) associated with the displayed optimized crown shape, the GUI being configured to receive user input for modifying at least part of the optimization information;
in response to user input for modifying the at least part of the optimization information, determining a re-optimized crown shape using the digital crown shape model based on the modified at least part of the optimization information; and;
displaying the optimized crown shape at the tooth position within the dentition.

13. The system according to claim 12 wherein the optimization information presented by the GUI includes at least one of: a crown pose, one or more landmarks, an emergence line, an FDI number, one or more dental corridors, one or more crown shape parameters.

14. The system according to claim 13, wherein the digital crown shape model is defined as a linear combination of different basic crown shapes of a tooth wherein the crown shape parameters represent coefficients associated with each basic crown shape defining at least part of the one or more optimization parameters.

15. The system according to claim 12, wherein the digital crown shape model comprises at least one trained deep neural network, preferably a DeepSDF-based model, that is trained to generate different crown shapes as a function of one or more optimization parameters provided to an input of the at least one trained deep neural network, wherein the optimization parameters control at least a shape of the crown shape and, optionally, a pose of the crown shape.

16. The system according to claim 13, wherein re-optimization of the digital crown shape model after user modification of the optimization information comprises:
receiving one or more modified values corresponding modified optimisation information from the GUI;
computing a loss value based on the modified optimisation information and using the digital crown shape model; and,
minimizing iteratively the loss value by updating the crown shape parameters and/or crown pose parameters until the loss value satisfies one or more optimization conditions.

17. The system according to claim 16, wherein re-optimization of the digital crown shape model after user modification of the crown shape parameters further comprises:
receiving crown shape parameters associated with the optimized crow shape displayed in the GUI;
extracting one or more features from the crown shape parameters, wherein the extraction comprises identifying features that represent variations in the crown shape parameters;
labelling a predefined set of the extracted features;
regenerating the crown shape parameters based on the set of labelled features;
providing a labelled set of features as editable inputs for the GUI; and
using the modified values of the labelled features to further optimize the pose of the crown shape by iteratively minimizing a loss function, wherein the loss function is minimized by updating the crown pose parameters until one or more optimization conditions are satisfied.

18. System according to claim 17, wherein extracting one or more features from the crown shape parameters comprises: performing principal component analysis (PCA) to reduce dimensionality of a space associated with the crown shape parameters, wherein principal components represent the most significant variations in crown shape geometry.

19. The system according to claim 18, wherein extracting one or more features from the crown shape parameters comprises: using an auto-encoder neural network to reduce the dimensionality of the crown shape parameter space, wherein a latent representation produced by the auto-encoder neural network encodes the most significant geometric and structural variations in the crown shape geometry.

20. A non-transitory computer readable storage medium having instructions which, when executed by a computer, cause the computer execute a method for automatic generation of a crown shape for a dentition for a crown, the method comprising:
determining an optimized crown shape for a tooth position in the dentition using a digital crown shape model, the digital crown shape model being associated with optimization information, the optimization information including one or more optimization parameters, wherein optimization comprises: generating a trial crown shape using the digital crown shape model; computing a loss value for the trial crown shape based on 3D spatial constraints associated with the dentition and an initial pose of the crown; and iteratively minimizing the loss value by modifying the one or more optimization parameters until one or more optimization conditions are met;
displaying the optimized crown shape at the tooth position within the dentition and a graphical user interface (GUI) associated with the displayed optimized crown shape, the GUI being configured to receive user input for modifying at least part of the optimization information;
in response to user input for modifying the at least part of the optimization information, determining a re-optimized crown shape using the digital crown shape model based on the modified at least part of the optimization information; and;
displaying the optimized crown shape at the tooth position within the dentition.
